(19) United States
(12) Patent Application Publication
(10) Pub. No.: US 2005/0097160 A1
(43) Pub. Date: May 5, 2005

(54) Method for providing information about a site to a network cataloger

(76) Inventor: James A. Stob, St Charles, IL (US)

Correspondence Address: ANDREW B. KATZ, 2000 MARKET STREET, 10TH FLOOR, PHILADELPHIA, PA, 19102, US

(21) Appl. No.: 10/971,520

(22) Filed: Oct. 22, 2004

Related U.S. Application Data
(63) Continuation of application No. 09/585,812, filed on May 19, 2000.
(60) Provisional application No. 60/135,370, filed on May 21, 1999.

(51) Int. Cl. G06F 15/16

(52) U.S. Cl. 709/200

(57) ABSTRACT

The present invention manages website visibility. In accordance with the present invention, webpage URLs within websites will be efficiently and effortlessly submitted and catalogued with Internet cataloging search engines. In accordance with one feature of the invention, webpage URLs may not be submitted if the maximum number of submittals have been reached. In accordance with another feature of the invention, webpage URLs may not be submitted if the webpage has not been modified since the last submittal, unless it is no longer in the search engine. Additional features are provided for managing a websites visibility.

### RELATED APPLICATION

This application claims the benefit of U.S. Provisional Application Ser. No. 60/135370, filed May 21, 1999 and entitled “Website Management”.

### FIELD OF THE INVENTION

The present invention relates to website visibility management. More particularly to submitting webpages to Internet cataloging websites and improving website visibility.

### BACKGROUND OF THE INVENTION

The Internet, world wide web (WWW) is growing rapidly. Websites are being added to the Internet daily and at a blazing pace. Websites are also becoming larger and it is not atypical for a website to have over 100,000 webpages or more.

When a website is added to the Internet it has a unique address so it may be found. The unique address is both the domain name, and the corresponding IP (Internet Protocol) address. The IP address is unique to the website, as is the domain name. An IP address is typically a 32-bit number that identifies a particular network on the Internet.

When using a web browser you may reach an Internet site by using the IP address, eg. 209.176.240.155, or you may use the corresponding domain name, eg. Positionpro.com. A URL (Uniform Resource Locator) is the address of a file accessible on the Internet. The URL contains the name of the protocol required to access the resource, in the case of web pages the protocol would be the HTTP (the Hypertext Transfer Protocol) and a domain name to identify a specific computer on the Internet, along with a file or directory path if necessary.

When using a URL to view the webpages at the PositionPro website, you could use the IP address as http://209.176.240.155/, or the protocol and domain name as http://www.positionpro.com. Most users find the protocol and domain name easier to remember than the IP address.

Each webpage within a site has a unique name, for instance there may be two webpages on a website, one entitled “contact.html” and one entitled “company.html”. To reach the contact webpage you would need to use the URL http://www.positionpro.com/contact.html, and for the company webpage http://www.positionpro.com/company.html. Every webpage has a unique name.

For a person to find a website they must remember the URL or else find the URL on a website, a magazine, or newspaper etc. Websites are usually found from links on other websites, and most often found from links on Internet cataloging websites. Links are URL's which a user may click with their mouse directing the user to the webpage the link points to.

Internet cataloging websites, search engines, include both directories and crawling search engines. Directories may only catalog the main URL for the website, eg: http://www.positionpro.com. Crawling search engines typically catalog a portion or the entire website, therefore multiple URLs are cataloged, eg: http://www.positionpro.com, http://www.positionpro.com/company.html, and http://www.positionpro.com/contact.html.

Popular directories include Yahoo, Open Directory, Snap, LookSmart. Popular crawling search engines include: Alta Vista, Excite/AOL, Inktomi, Infoseek, Lycos, and Webcrawler.

As Internet users search for websites they type in keywords, terms, phrases, etc., into an Internet cataloging website. These searches may return 1,000, 10,000, or more webpages with those phrases. More than likely only the top 10 or 25 URLs are shown to the user without having to click a link to view another webpage. These top 10, 25, and even. 50 positions are well coveted. The positions of webpages differ depending on the keywords, terms, phrases, etc., that the searcher enters and are matched with the keywords, terms, and phrases found within the code of the webpages.

Some Internet cataloging websites, crawling search engines, will crawl the Internet, known as “webcrawlers”, in order to find and then index the URLs and text of the webpages that were found during the crawl. Other Internet cataloging websites, and some crawling search engines, require that someone submit the URL through a form on the Internet cataloging website. Once the website is found the website may be searched, known as “spidering”, to find additional webpages.

Spidering is the act of finding the original URL webpage and then following each link, a URL directing a user to the associated webpage, found within the webpage. Spiders typically do not spider farther down than one or two links from the main webpage, leaving many webpages uncatalogued. Spiders also typically only follow links found within the main webpage. Links that are not on the main webpage may never be spidered.

Since websites want traffic, users to visit their site, it is very important that the webpages within a site be indexed on an Internet cataloging website. Some Internet cataloging websites do not crawl or spider, and require someone to enter each individual URL for each webpage within the website. However, this is not an easy task, entering each URL manually into each Internet cataloging website is time consuming and laborious. Only a few Internet cataloging websites were mentioned, however hundreds if not thousands exist.

Even if someone was able to manually submit each URL from a website into all the Internet cataloging websites they wished to be indexed in, the Internet cataloging websites are not perfect and may lose URLs. This requires that the URLs be resubmitted, but you never know which Internet cataloging website has lost a URL, which URL was lost, and when it was lost, unless you search the Internet cataloging websites one at a time, for each and every URL.

Users must also submit URLs frequently, not all Internet cataloging websites catalog every URL given to them. Internet cataloging websites also typically have daily, weekly, and monthly quotas on the number of URLs that may be submitted from a given website. Therefore, it may take multiple submissions before a URL is cataloged. Someone has to keep track of how many URLs were submitted to each engine, which URLs were submitted to which engine, and when each URL was submitted to which engine.

Another difficult task is keeping track of the URLs. Additional webpages are created for websites constantly, so URLs may change, new URLs may be created and URL's removed. This is another time consuming task. URL's may also be dynamic. Dynamic URL's are created at the time the user clicks on a link or otherwise requests a webpage that is automatically created by a program on the website, an example is a webpage tailored to the user by placing the users name within the webpage to personalize the webpage.

With all the restrictions regarding URL submissions, submitting a URL for a webpage that was submitted previously and is still in the engine should not be done, and is a waste of resources, if the URL webpage content has not changed. It is very difficult for someone to determine whether the webpage has changed since the last time it was submitted.

It is also very important to comply with Internet cataloging website rules for submissions. If a user submits too often, follows the wrong process, or makes other mistakes which an Internet cataloging website may discourage, the user runs the risk of having their URL removed, or not cataloged in the first place, or worse their domain name may be banned from ever being catalogued.

Once a URL is catalogued within an Internet cataloging website, the owner of the URLs would like to know the ranking of each URL within each cataloging website, know when each URL's ranking changes, when a URL has been removed, and otherwise track the URLs of the website.

Services exist to submit a given website URL to a number of Internet cataloging websites. However these services simply submit a URL which is provided manually by a user. A user must determine when to submit URLs and perform a submission. For websites with a large number of URLs, 1000 or more, the process of manually submitting each URL to a service for submittal is also laborious and cumbersome. Some existing services may also submit multiple URLs to a website.

The disadvantages of the current services are solved by the present invention.

### FEATURES AND ADVANTAGES

The present invention provides multiple advantages, including but not limited to the following:

(1) Website URL's may be resubmitted, through an automated process, using user preferences such as: time for resubmittal, date of resubmittal, after checking to see if the URL is already indexed in an Internet cataloging website, after checking to see if the indexed URL has achieved an acceptable ranking, after checking to see if the indexed URL has achieved an acceptable ranking for user specified key words;

(2) webpage titles, meta-tag descriptions, and meta-tag keywords, may be viewed for all website URLs in a unique, manageable layout so the user may determine if changes to webpages need to be made before a URL is submitted;

(3) when webpages using techniques that disallow the URL to be submitted to an Internet cataloging website, the URL may be modified so as to allow submittal;

For example webpage URLs utilizing frames may be submitted, but the webpages within the frames with the content are not viewable by the Internet cataloging website. The present invention allows submittal of webpages found within frames.

Another example is the use of an image map, an image which allows a user to chose a portion of the image by clicking on it and being sent to another webpage through the URL associated with the chosen coordinates of the image map, if references to links are not found then the spider cannot follow the links, the current invention is capable of spidering image maps to obtain URL's.

Yet another example is the passing of parameters by webpages, which Internet cataloging engines are unable to catalog. By removing the parameter passed it is possible to create a catalogable URL;

(4) the entire website, all webpages, may be spidered;

(5) all URLs from spidered webpages may be submitted, and a user may choose not to submit some or all of the webpages, the present invention may also choose not to submit some or all of the webpages based on predetermined criteria;

(6) server logs, which are flat files containing information regarding website traffic, such as who came to the site, when they came, how they got there, if they used an Internet cataloging website—which terms did they use to search and find the URL, etc., may be used to glean valuable information which may be used to create optimized webpages in an effort to achieve more relevant search results;

(7) the present invention may also limit the links submitted to a subset of all links found on the website, either specified by the user, or determined by the present invention in an effort to follow Internet cataloging engines rules;

(8) the present invention spiders the website, and spiders the entire website, unless instructed otherwise;

(9) the present invention may keep track of when the website webpages were last spidered;

(10) all website webpages are tracked, both internal website links and external website links;

(11) external website links may be tracked as well, and whether or not the links are valid is also tracked;

(12) an Internet catalog engine spider does not spider a page, directory, or entire site, located in a robots.txt file, while the present invention may spider the entire site, including links from webpages within a webpage which is within the robots.txt file, for completeness;

(13) the present invention may save each webpage that is spidered and upon future spidering the webpages will be compared to determine whether any changes have been made, if changes have not been made then the webpage does not have to be resubmitted;

(14) depending on Internet catalog engine rules, or at a users request, a limited number of website URLs may be submitted at any one time, based on time of day, day of month, etc.;

(15) pages may also be selectively submitted to Internet catalog engines based on whether or not they have a ranking, or an acceptable ranking, within the Internet catalog engine;

(16) the present invention spider can count levels of directories to determine how deep the spider has penetrated the website;

(17) test the webpage code to check for errors before submitting the URL to an Internet catalog engine;

(18) submittal of webpage URLs from files, instead of webpage spidering, since URLs may not be linked to a main page that would be found by the Internet catalog engine's spider;

(19) URLs may be selectively submitted, based on criteria such as the newest URL links found, last submitted, first submitted, lowest Internet catalog engine rankings in general or for specific keywords;

(20) determine how high a URL for a webpage ranks based on keywords;

(21) suggest keywords to be used based on the webpage or prior search results;

(22) rankings and reports show progress being made, submission strategies may be revised based on the results;

(23) allowing a file of links to be read and spidered without submitting the main file containing the links, thereby keeping the master link file anonymous and unavailable to internet catalog engines;

(24) when searching an Internet cataloging engine for rankings of a domain name, URL's may appear for the chosen domain which have not been found by the spider, these may be URL's which are no longer active, these URL's will be noted as found and the domain checked to determine if the URL is “not found” or what the status is, also the ranking and other statistics may be kept, and

(25) all of the results of the above features may be reported both on-screen and off-line, to a printer, file, database, etc.

### SUMMARY OF THE INVENTION

The present invention manages website visibility. In accordance with the present invention, webpage URLs within websites will be efficiently and effortlessly submitted and catalogued with Internet cataloging search engines. A variety of features are provided to create a website and webpages which may be more easily received by the Internet cataloging website. In accordance with one feature of the invention, webpage URLs may not be submitted if the maximum number of submittals have been reached. In accordance with another feature of the invention, webpage URLs may not be submitted if the webpage has not been modified since the last submittal, unless it is no longer in the search engine. Additional features are provided for managing a websites visibility.

### BRIEF DESCRIPTIONS OF THE DRAWINGS

FIGS. 1 through 4 are block diagrams illustrating the process of the present invention.

FIG. 1 is a block diagram of the present invention process.

FIG. 2 is a block diagram continuation of the present invention process in FIG. 1.

FIG. 3 is a block diagram continuation of the present invention process in FIG. 2.

FIG. 4 is a block diagram continuation of the present invention process in FIG. 3.

FIGS. 5 through 32 are screen shots of the present invention.

### DETAILED DESCRIPTION OF THE INVENTION

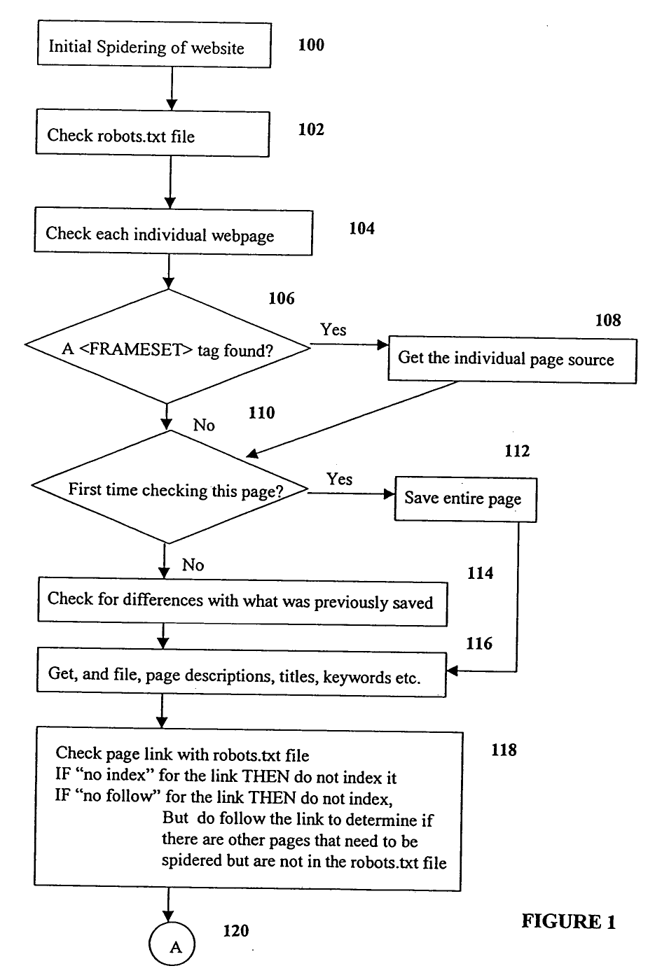

Referring now to the figures, FIG. 1 is a block diagram of the present invention process. Step 100 begins the process with an initial spidering of a website. It is preferred to spider the website by moving through the directories to find the webpages, therefore the entire website will be spidered and all webpages found. Webpage URLs may be created by using the domain name and directories to create acceptable URLs.

Spidering by pulling URLs out of the main webpage will not find webpages which are not linked off of the main webpage or a subsequent webpage. By moving through the directories of the website every webpage will be uncovered and an acceptable URL created. All the webpages within the website are obtained.

Step 102 then checks the robots.txt file. A robots.txt file is a universally known file used on websites to inform spiders and others searching through the website which webpages should not be indexed by an internet cataloging engine. Directories are also specified.

Step 104 then checks each individual webpage found. Step 106 determines for each webpage, whether there is a “<FRAMESET>” tag found in the webpage code. A “<FRAMESET>” tag designates that the webpage has frames. Pages source for each webpage linked off of the frame webpage needs to be found, in step 108.

Step 110 then determines if this is the first time the webpage has been found. If this is the first time this webpage has been found then the entire webpage may be saved into an archive area in step 112. The saving off of webpages is performed so the archived webpage may be compared to currently visible webpages on the website to determine if changes have been made that would warrant another submission to an internet cataloging search engine.

Step 114 is reached only if the webpage has been checked before, and therefore has an archived version. The archived version of the webpage is compared with the currently visible webpages on the website to determine if changes have been made. If changes have been made then the page is noted to be a possible resubmission. If changes have not been-made then the page is noted as not having changed.

Step 116 then parses the webpage code to obtain common attributes: such as the page titles, metatags containing keywords, descriptions, and other common attributes. These attributes are used by Internet cataloging engines as one indicator of relevancy when retrieving search results. Therefore, webmasters like to view these attributes in a manner that is easy to read and determine what is lacking and what needs to be modified, or what is working well when comparing the ranking results to the common attributes.

Step 118 then checks the robots.txt file to determine if the individual webpages are listed as files not to be indexed. If the individual webpages are tagged as not to be indexed then the webpage is tagged so that they will not be sent to an Internet cataloging website. If the webpage is listed as not to be followed, then the webpage is tagged so it will not be indexed, but continue to follow the file anyway for additional links.

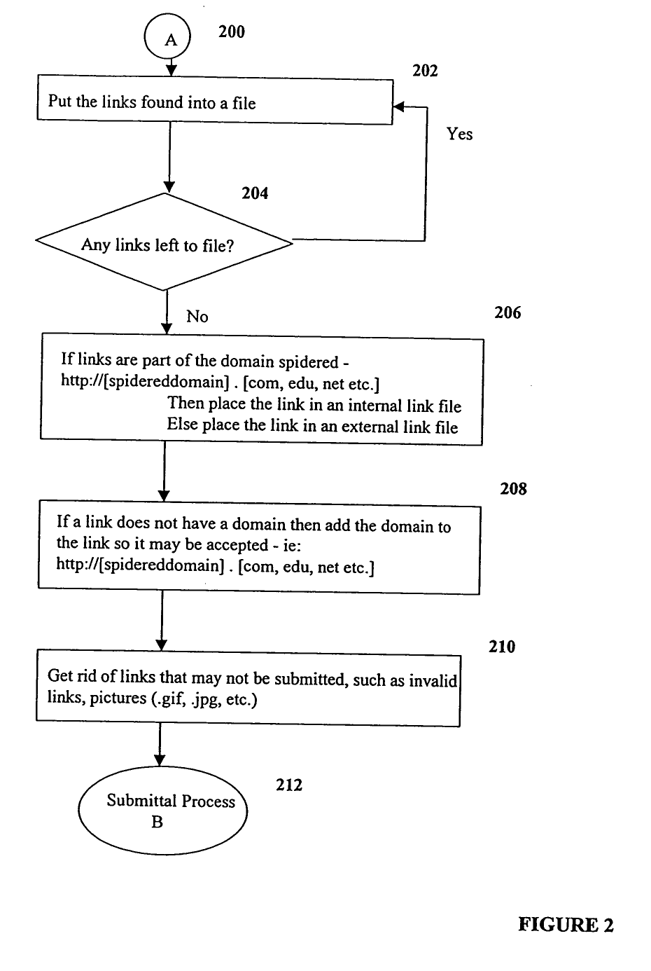

Step 118 then passes to continuation step 120 which continues in FIG. 2 as step 200. FIG. 2 is a block diagram continuation of the present invention process in FIG. 1.

Continuation step 200 passes on to step 202. Step 202 creates a file of all the webpages found on the website. Step 202 then passes to step 204. Step 204 decides whether webpages still need to be placed in the file. The process then passes to step 206

Step 206 then determines if the links found are within the current website or are external. If the links are within the current website then they are placed in an internal link file. If the links are external to the website then they are placed into an external link file.

Step 208 then determines if the links found in the files will be acceptable to Internet cataloging engines. An Internet cataloging engine can only accept links that will direct a user to a webpage when clicked. A link is a URL which has the address of a file accessible on the Internet. The URL contains the name of the protocol required to access the resource, in the case of web pages the protocol would be the HTTP (the Hypertext Transfer Protocol) and a domain name to identify a specific computer on the Internet, along with a file or directory path if necessary. For example, http://www.positionpro.com/price.cfm, or http://209.176.240.155/price.cfm.

If a link, the file, does not have the domain then add the domain name and appropriate directories. The domain in this illustrative example is simply “positionpro.com”. So for a file named “price.html” within a directory named “price”, the resulting URL would be http://www.positionpro.com/price/price.html. This URL would be acceptable to an Internet cataloging website.

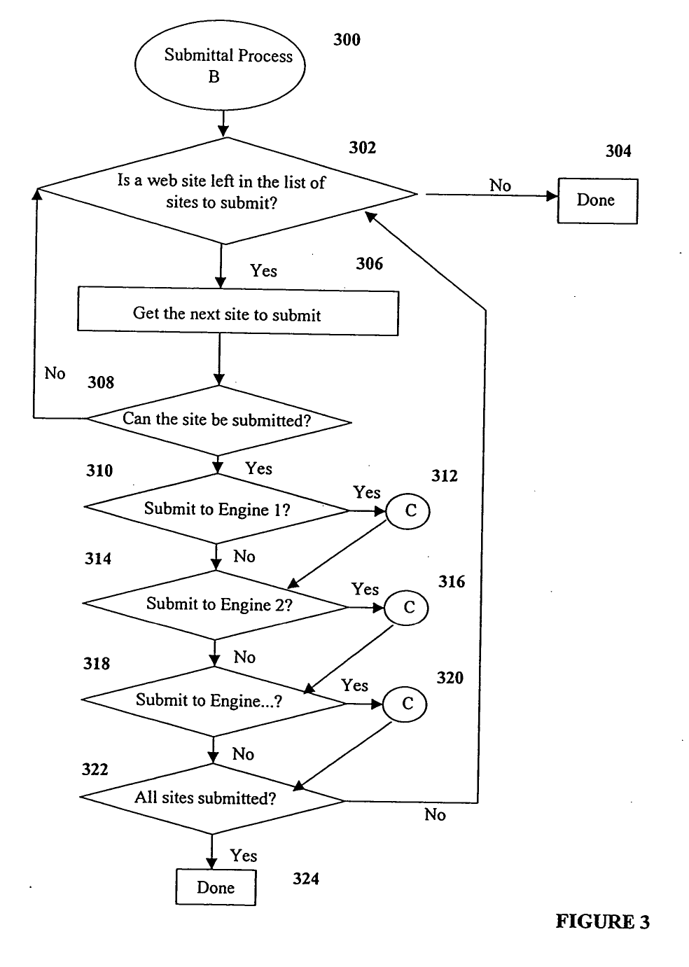

Step 210 then removes links, files, which would not be valid to submit to Internet cataloging websites. Such invalid files would be pictures, such as JPEG and GIF files, and others non-webpages. Step 212 then begins the submittal process which continues in FIG. 3.

FIG. 3 is a block diagram continuation of step 212 in FIG. 2. Step 300 begins the submittal process by passing the process to step 302. Step 302 determines if there are websites in the queue to be submitted to the Internet cataloging websites. If there are not websites left to be submitted then the process ends at step 304. If additional websites are left the process passes to step 306.

Step 306 retrieves the domain name of the next website to be submitted to an Internet cataloging website. Step 308 then determines if the website may be submitted. A website may not be submitted for a variety of reasons. It is possible that the particular website is not to be submitted until the next submission process, and the user of the process can determine when websites should and should not be submitted.

If the website is to be submitted, then step 308 passes the process on to step 310. If the website is not to be submitted, the process passes back to step 302 to determine if additional websites are in the queue to be submitted.

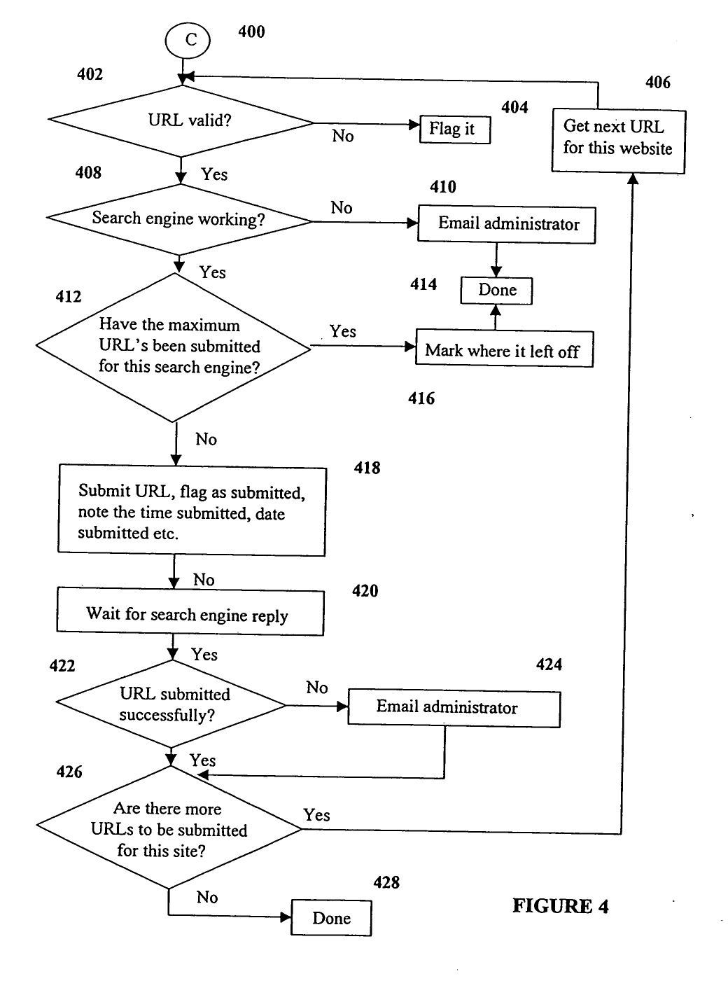

Step 310 then determines if the website is to be submitted to the first Internet cataloging website in the list of websites. Steps 310, 314, and 318, each determine if another Internet cataloging website is to be submitted to. In each step 310, 314, and 318, if the Internet cataloging website is to be submitted to then the process passes to step 312, 316, and 320, respectively. Each step 312, 316, and 320 then pass the process to step 400 shown in FIG. 4 for submittal to the Internet cataloging website.

The process works down through 310, 314, and 318, and then on to step 322 to determine if all websites have been submitted to. If additional websites need to be submitted then the process passes back to step 302. If all websites had been submitted to then the process passes on to step 324 and is finished.

FIG. 4 is a block diagram continuation of the present invention process in FIG. 1. Step 400 begins the process. Step 402 determines if the URL is valid. Validity not only means acceptability by an Internet cataloging website, but also whether or not the URL points to an active webpage that exists and is obtainable over the Internet. If the URL is invalid then it is flagged in step 404.

If the URL is valid then step 408 determines if the Internet cataloging website is presently working or has problems. The Internet cataloging website may be pinged by sending out a test to determine if the submittal of a URL will return an error or work correctly.

If the Internet cataloging website is having problems and cannot currently receive URL submissions then the process passes to step 410. Step 410 immediately sends a notification via e-mail to the administrator of the present invention to inform them that submittals cannot be made for a particular Internet cataloging website and it needs to be investigated. In step 414 the process stops and is passed back to the process in FIG. 3 for submittal to another Internet cataloging website.

If the Internet cataloging website is working fine and can currently receive URL submissions then the process passes to step 412. Step 412 determines if the maximum number of URLs have been submitted. Internet cataloging websites have rules about daily, weekly, and monthly submissions and set a maximum number of URLs that may be submitted for any one particular domain. Once that number has been met the present invention ceases the submission of URLs to that particular Internet cataloging website.

Step 416 marks the file of URLs for the current website domain with the last URL to be submitted. The process passes to step 414 and the process is passed back to the process in FIG. 3 for submittal to another Internet cataloging website.

If the maximum number of URLs have not been submitted then the process passes to step 418. In step 418 the URL is submitted to the Internet cataloging website. The URL is then flagged as being submitted to that particular Internet cataloging website, and the time and date of the submission is recorded. The process then passes to step 420 to wait for a response from the Internet cataloging website.

Step 422 then determines if the URL was received successfully. If the URL was not received successfully then step 424 sends an email to the administrator of the present invention denoting that a problem occurred. The administrator is told which URL was to be submitted, which Internet cataloging website it was to be submitted to, date of submittal, time of submittal, and error message. The URL is also flagged as not received properly.

The process then passes to step 426 to determine if additional URLs need to be submitted for the website. If additional URLs need to be submitted then the process passes to step 406. Step 406 then obtains the next URL for the current website and passes the process on to step 402.

If additional URLs do not need to be submitted then the process passes from step 426 to step 428 and finishes submittal to the current Internet cataloging website and the current website. The process passes back to the process in FIG. 3.

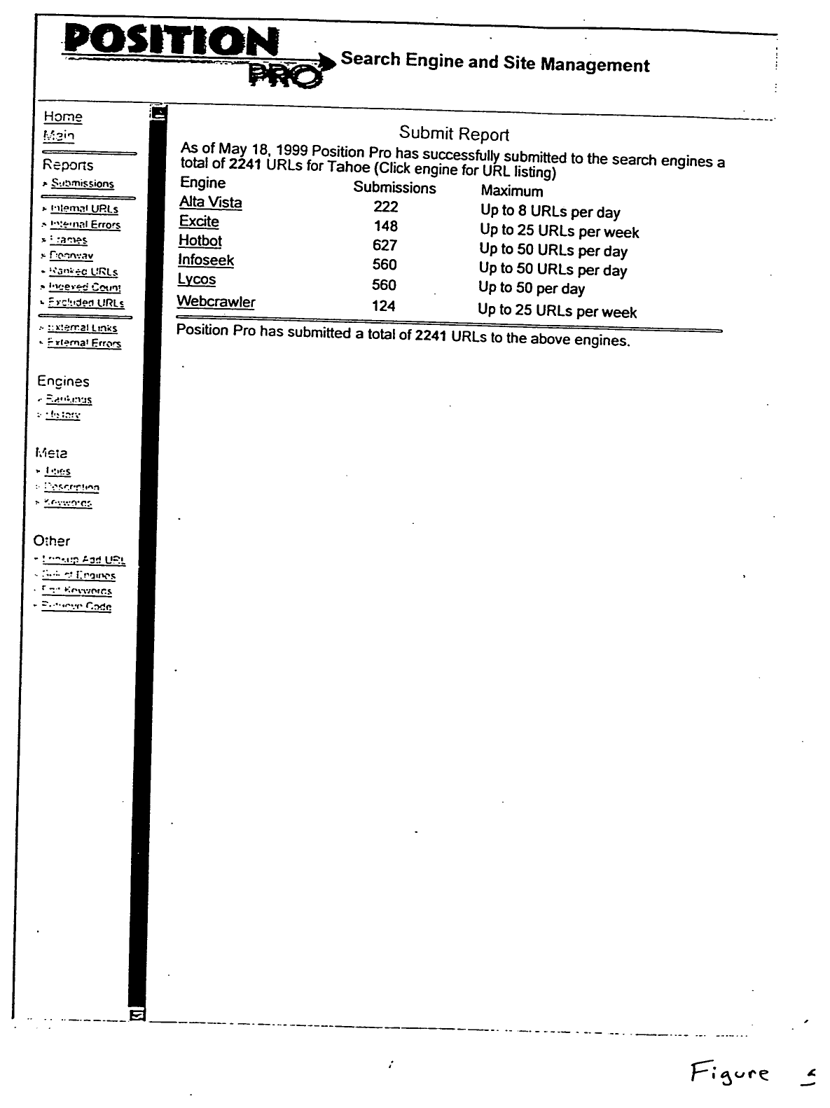

FIGS. 5 through 32 are screen shots of the present invention.

FIG. 5 is a screen shot of the present invention showing the number of URLs which have been submitted to Internet cataloging websites, the number of submissions to date, and the restrictions each Internet cataloging website has. Restrictions are shown as the maximum number of submissions each Internet cataloging website is able to receive per day and per week.

The screen shot shows a list of menu items down the left side of the screen as follows: Home, Main, Submissions, internal URLs, Internal Errors, Frames, Doorway, Ranked URLs, Indexed Count, Excluded URLs, External Links, External Errors, Rankings, History, Titles, Description, Keywords, Lookup/Add URL, Search Engines, Edit Keywords, Retrieve code. These menu items are repeated on every screen shot.

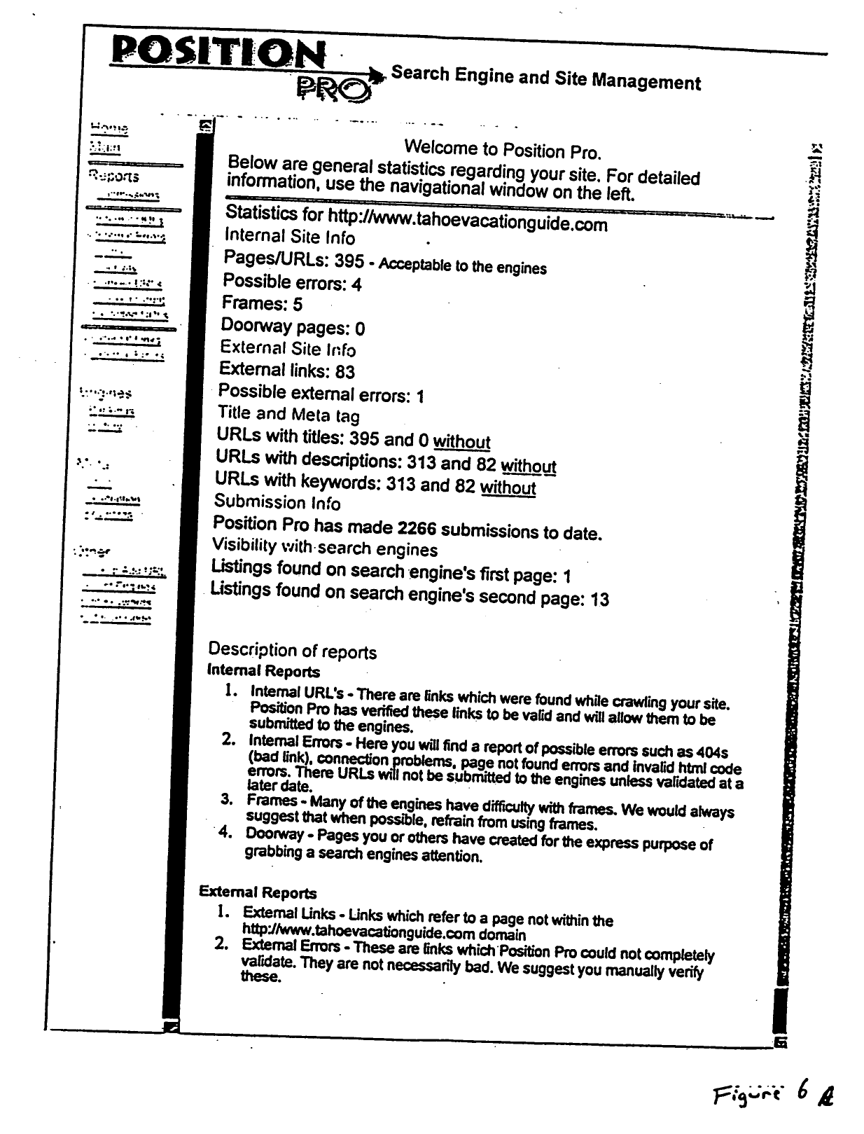

FIG. 6 is a screen shot of statistics for the current website being submitted to Internet cataloging engines, the website is shown as http://www.tahoevacationguide.com. Multiple statistics are shown: 395 pages were acceptable to search engines, with 4 possible errors, 83 external links found, 1 possible error, pages without titles, descriptions, keywords etc., and the total number of submissions are shown.

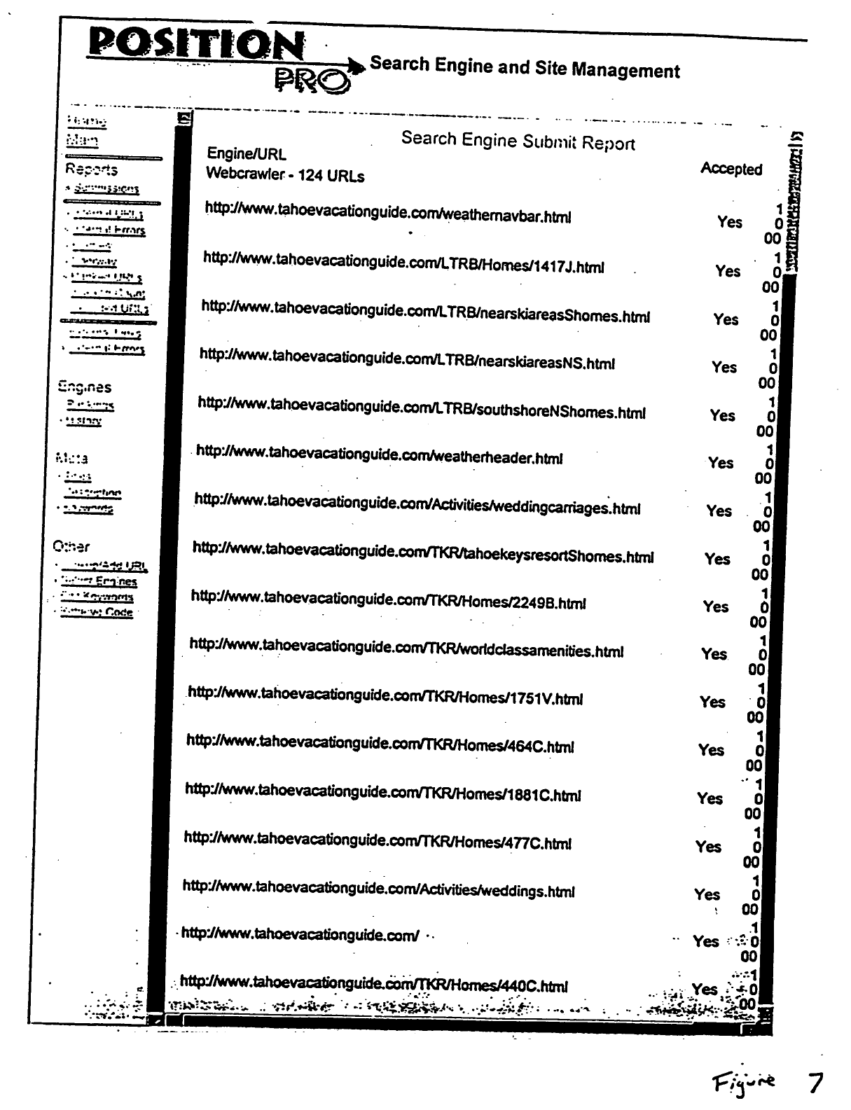

FIG. 7 is a screen shot of the individual webpages submitted to a specific Internet cataloging engine, and whether or not they were accepted.

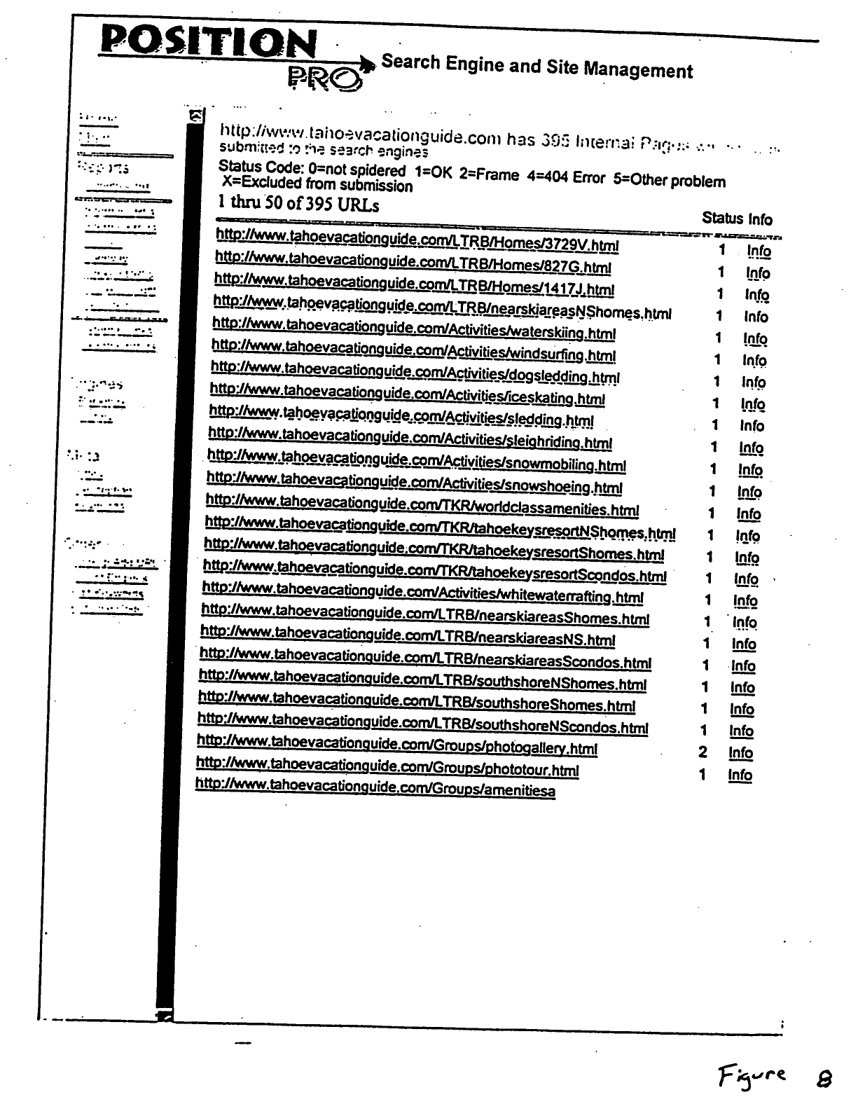

FIG. 8 is a screen shot of the individual webpages submitted to a specific Internet cataloging engine, and the status of each webpage.

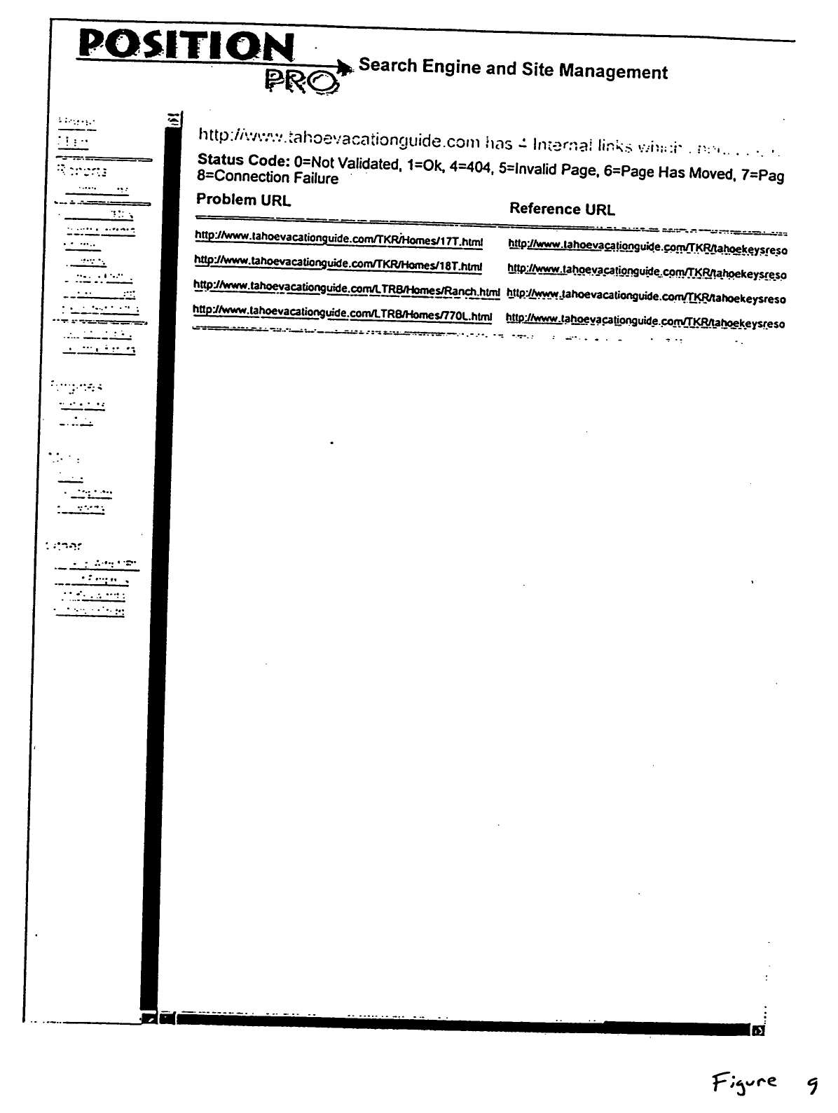

FIG. 9 is a screen shot of individual webpages that had a problem and the webpage that referenced the problematic webpage.

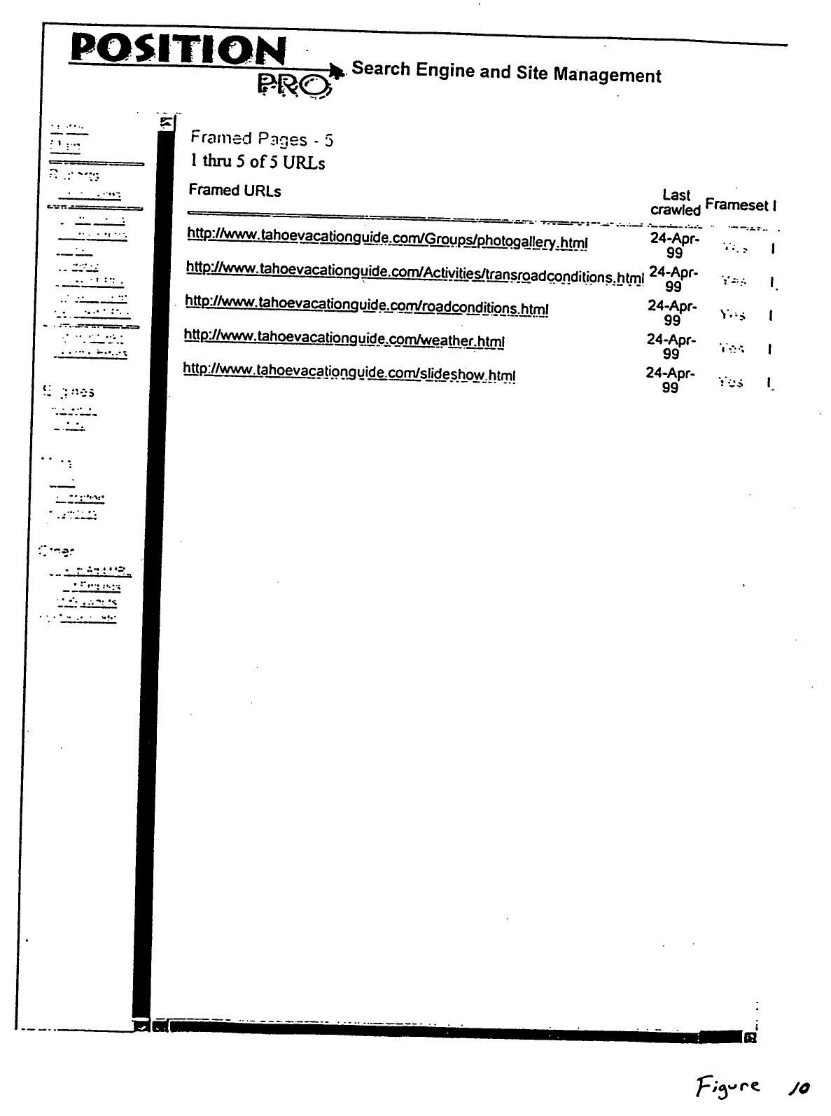

FIG. 10 is a screen shot showing the webpages that have frames and when they were last crawled.

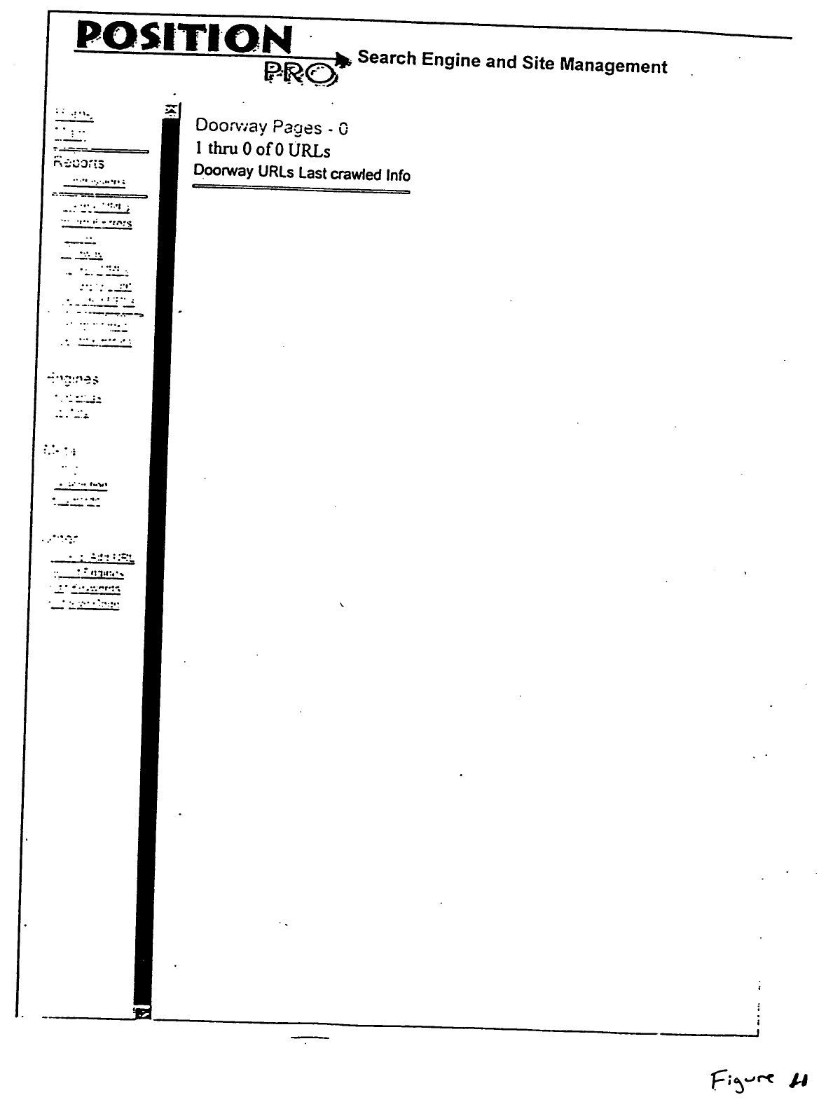

FIG. 11 is a screen shot of the doorway pages that were last crawled.

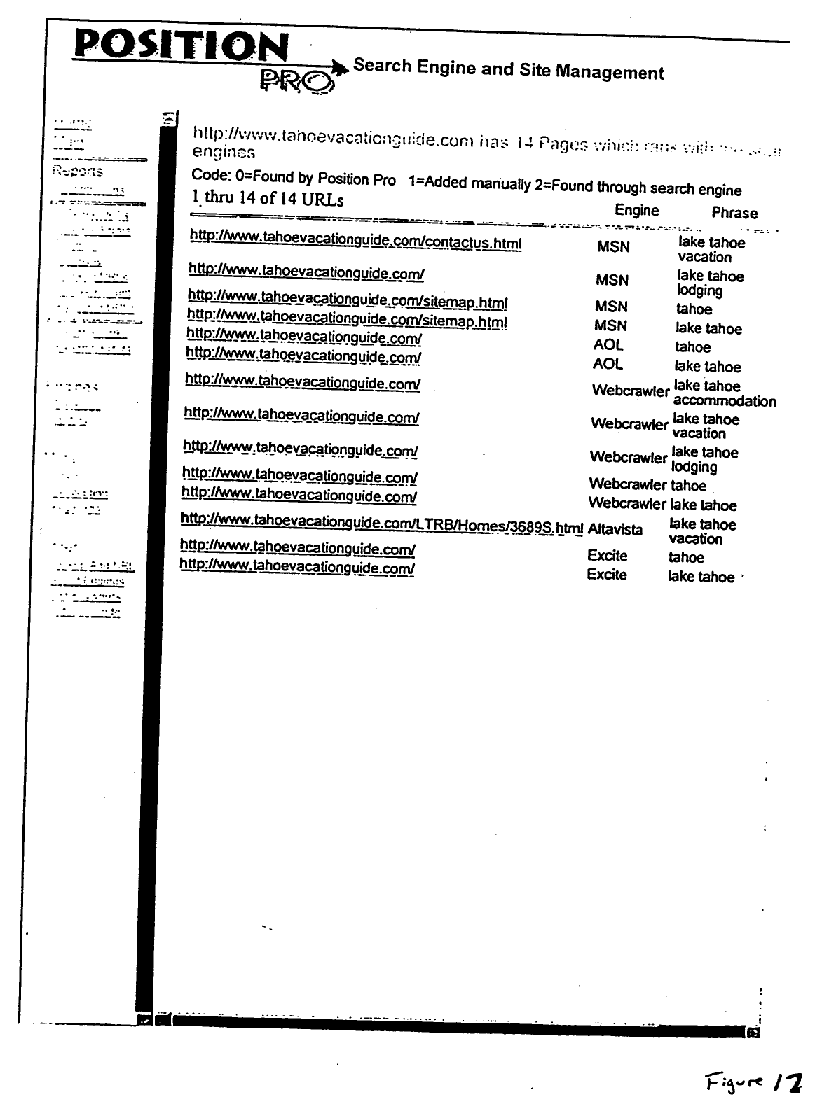

FIG. 12 is a screen shot showing webpages that rank within an Internet cataloging engine, which Internet cataloging engine they rank in, and the phrase that the webpage was found under when doing a query within the Internet cataloging engine.

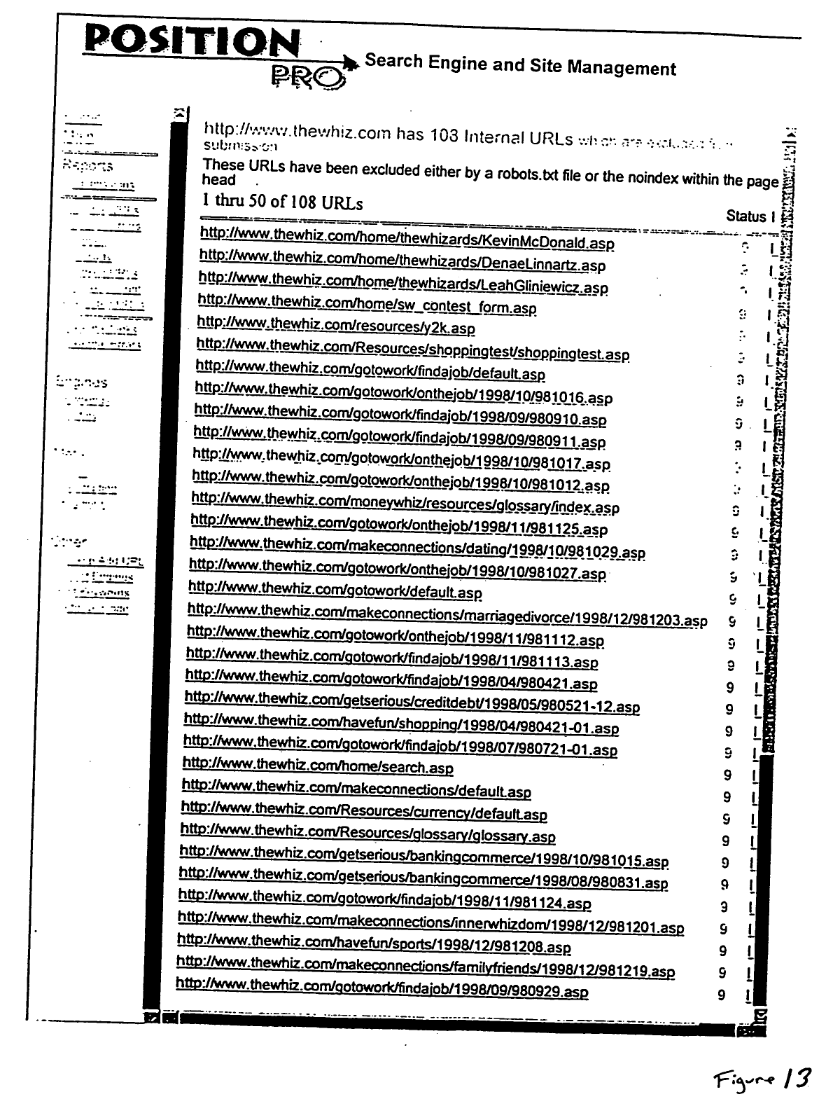

FIG. 13 is a screen shot of the URLs which have been tagged as URLs which should not be submitted to Internet cataloging engines, either by the robots.txt file or from a ‘noindex’ tag.

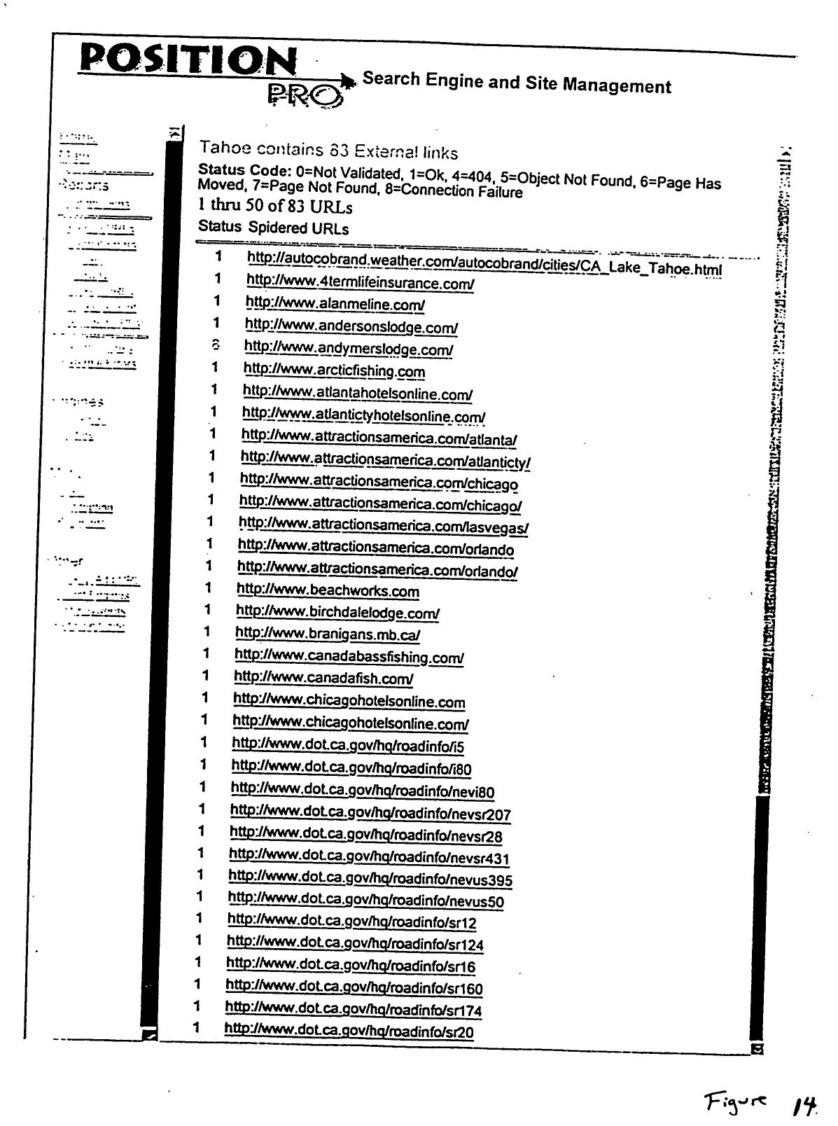

FIG. 14 is a screen shot of external links found within the website being submitted to Internet cataloging engines. The external links have codes associated with them to show if the external webpage is: not validated, okay, not found, moved, or there was a connection failure.

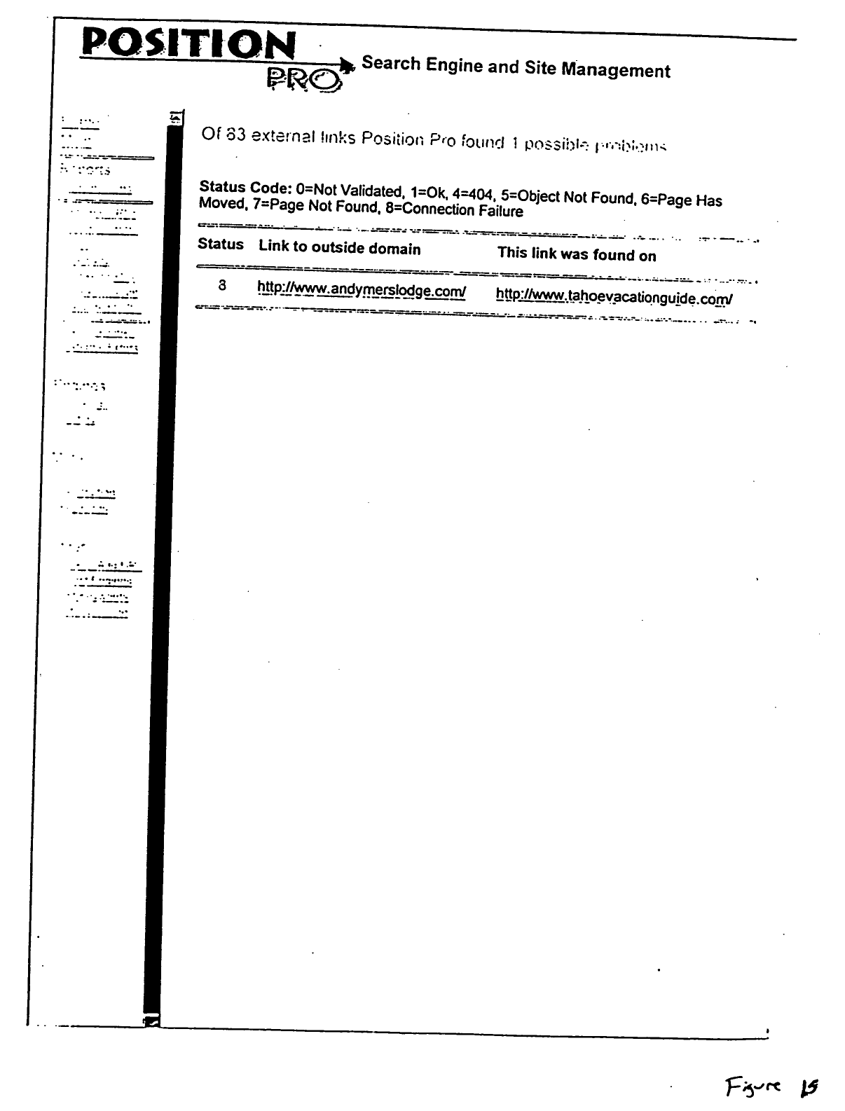

FIG. 15 is a screen shot of the one external webpage that showed a code which indicated a possible problem. Code number eight shows that there was an error connecting to the external webpage. A link showing the webpage that referenced the external link is also shown for debugging purposes.

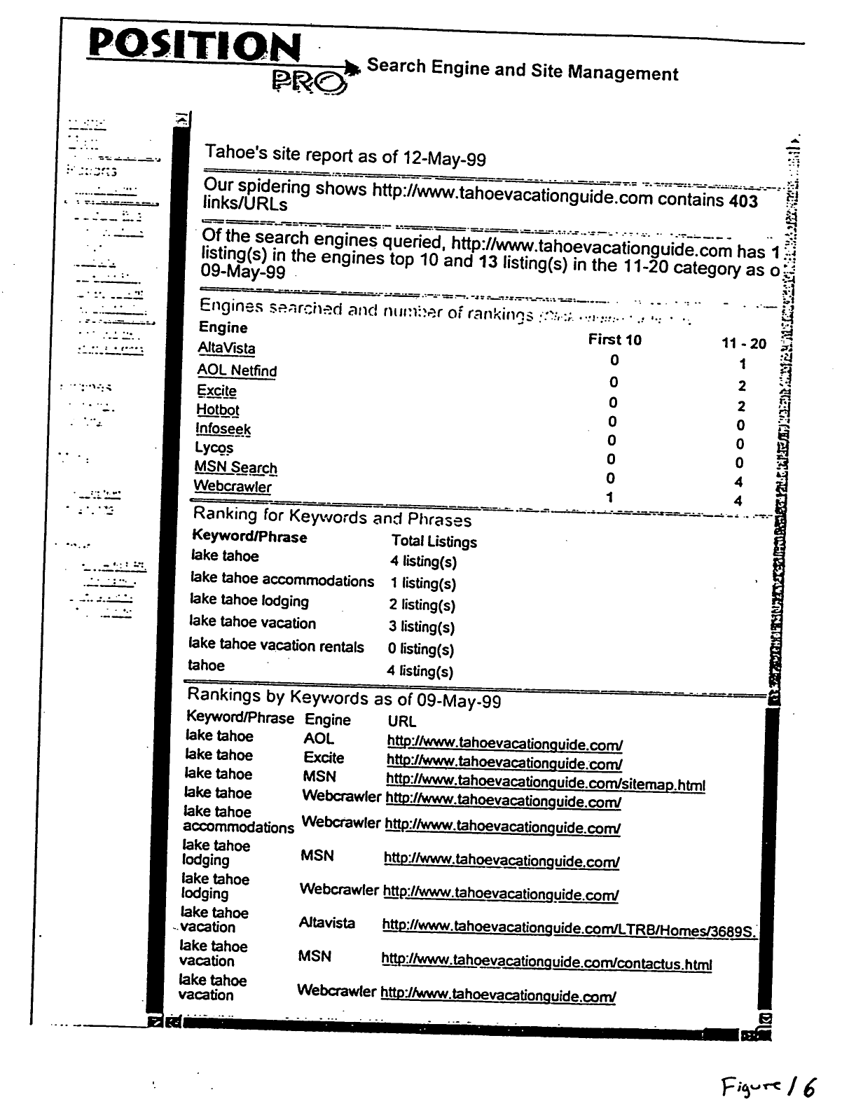

FIG. 16 is a screen shot of which Internet cataloging engines show a webpage from the domain name being submitted within the first 10 search results, and then within the second 10 search results. The words and phrases used when searching the Internet cataloging engines are also shown. Finally, the actual webpage that was found on each Internet cataloging engine is shown.

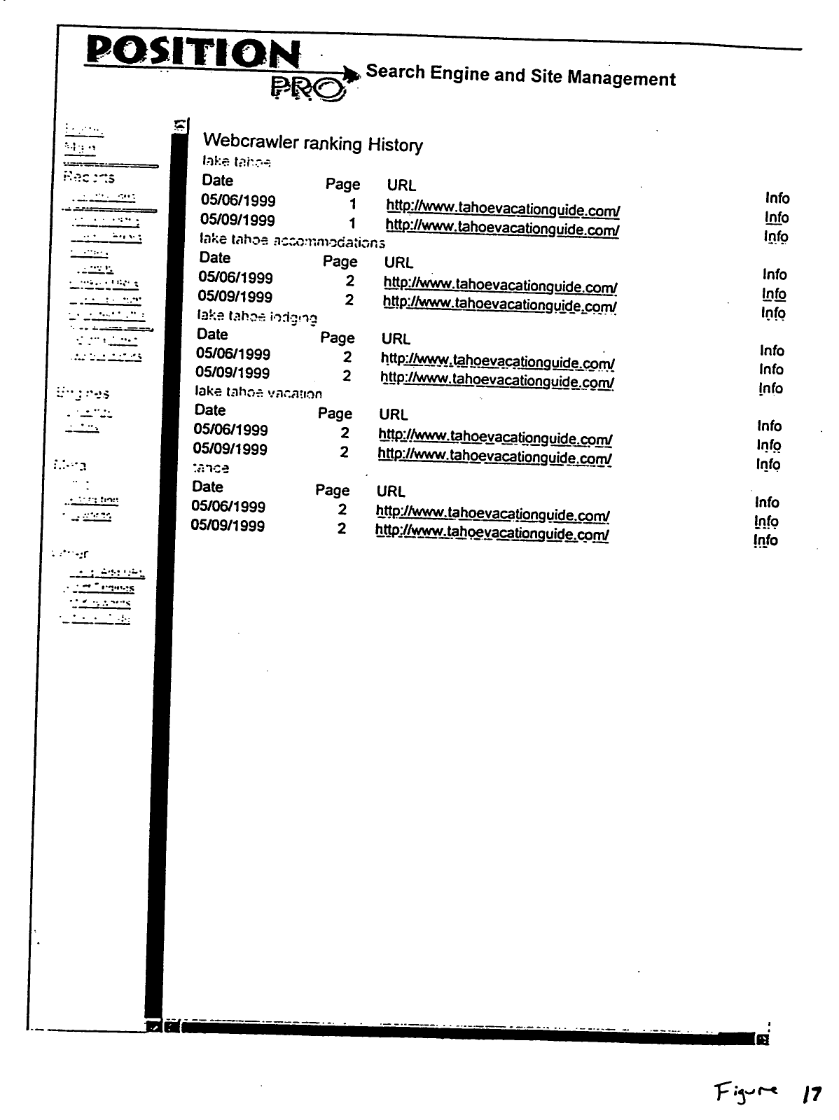

FIG. 17 is a screen shot of the webpages that were ranked within a given Internet cataloging engine, the date the webpage was found, and which search result page the webpage was found on. Additional information about each webpage can be found by following the “Info” link shown on the right side of the screen.

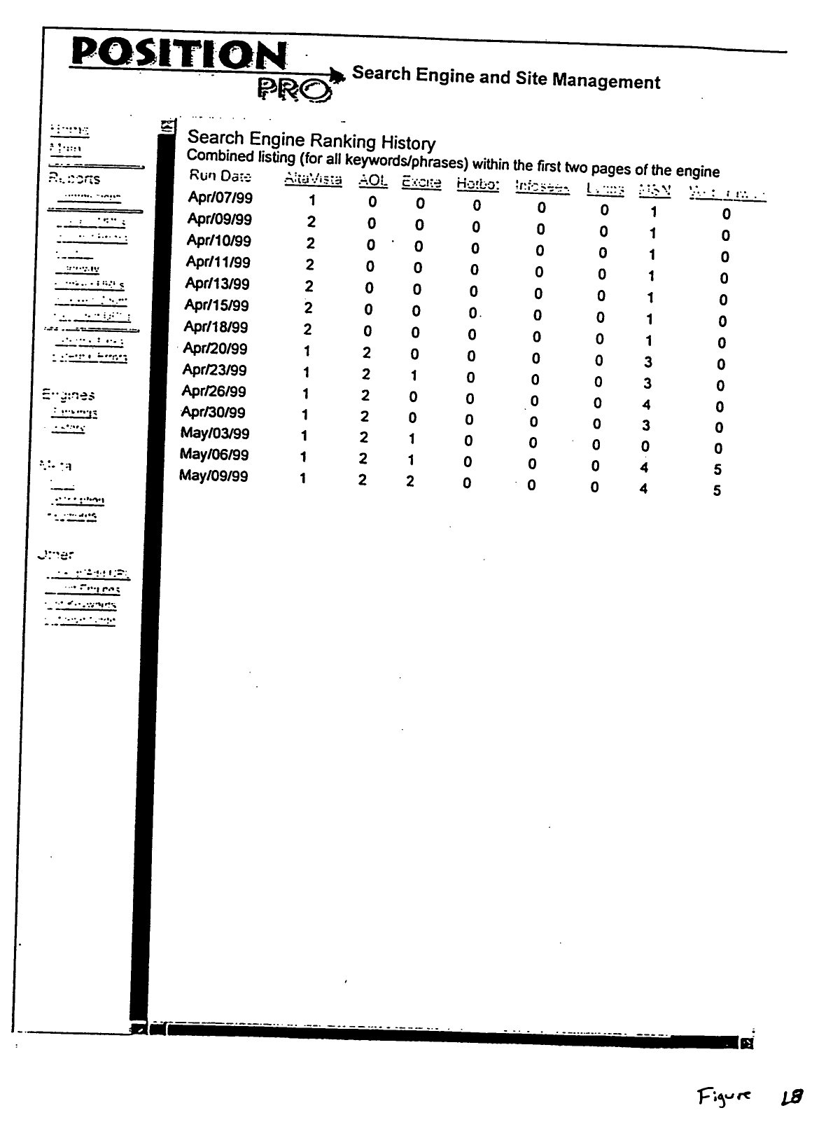

FIG. 18 is a screen shot of how many webpages of the domain name being submitted to the Internet cataloging engines were found within the first two pages returned by the Internet cataloging engines, on specific dates.

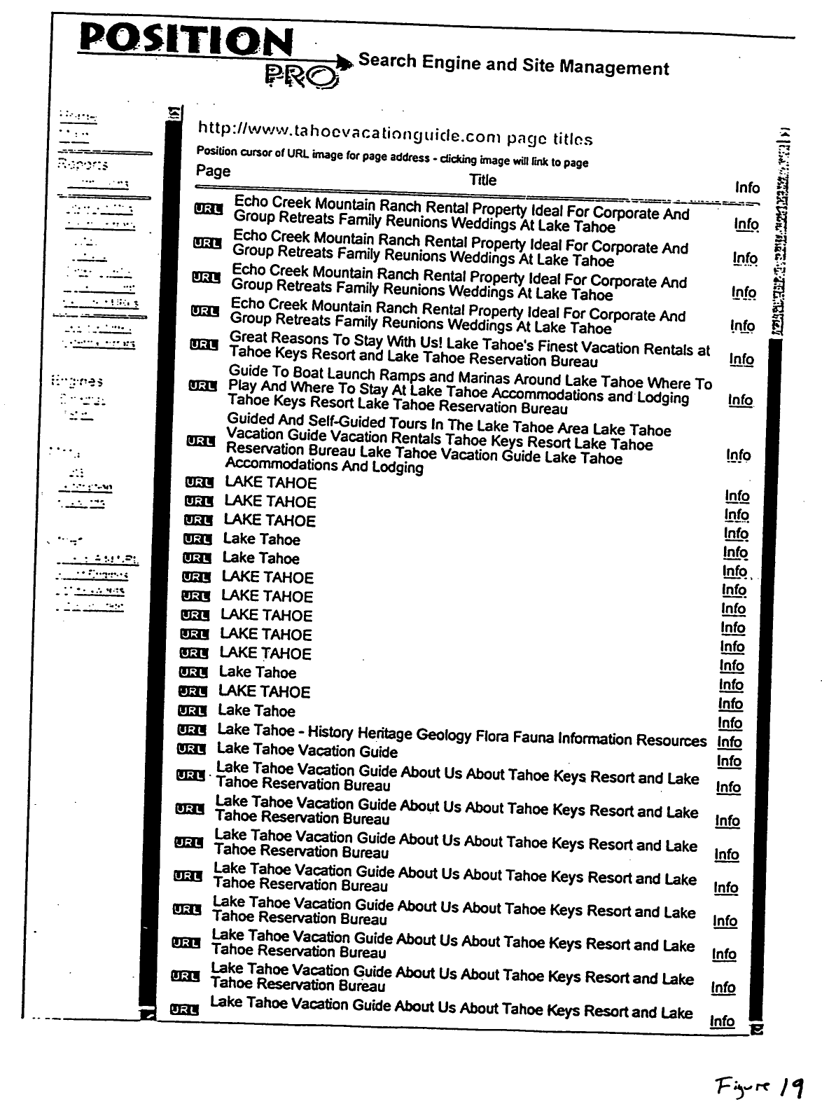

FIG. 19 is a screen shot showing the titles of all the webpages within the domain that is being submitted to Internet cataloging engines. The purpose is to show the webmaster whether they have any titles at all, or whether they are writing effective titles. In many cases, as this screen shot shows, the web programmer simply used the same title for multiple webpages, which does not assist a user searching for the information found on the webpage if the title does not reflect the information found on the webpage.

The title is shown in the title bar of the web browser and is used frequently by Internet cataloging engines to assist in finding relevant search results. The screen shot assists in showing whether or not the web programmer is effectively using webpage titles.

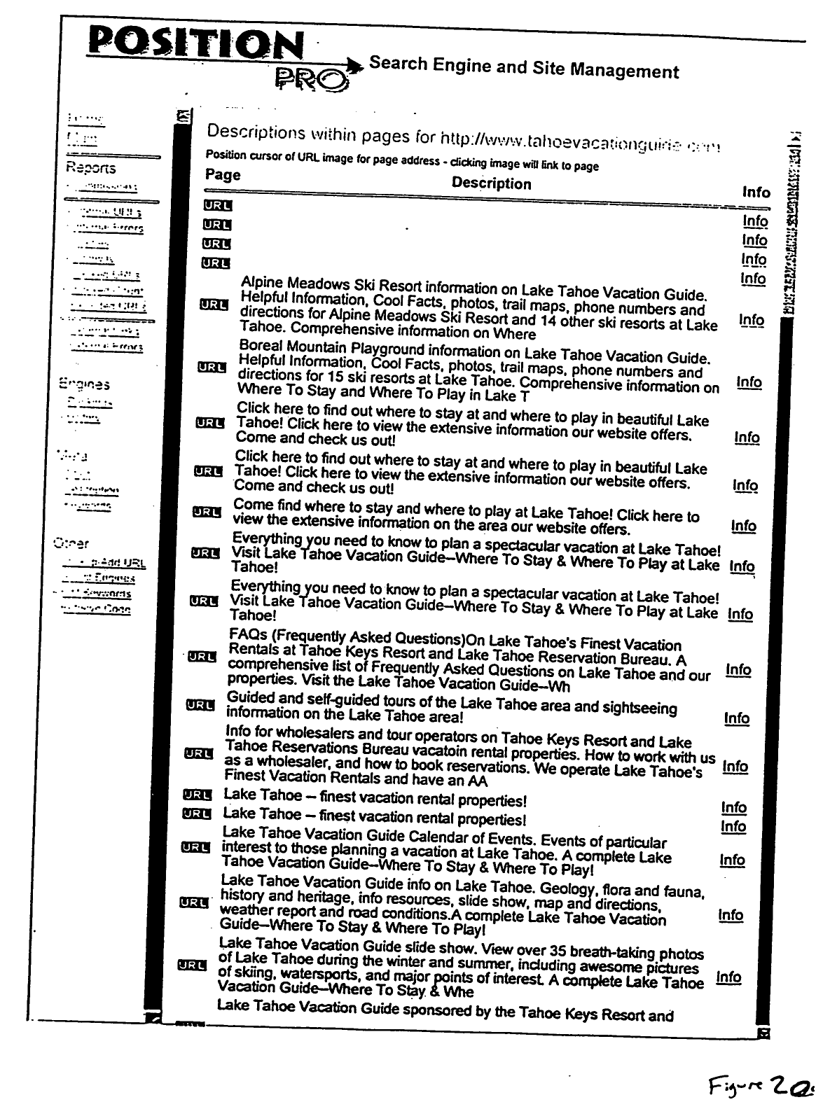

FIG. 20 is a screen shot showing the descriptions of all the webpages within the domain that is being submitted to Internet cataloging engines. The screen shot assists in showing whether or not the web programmer is effectively using webpage descriptions.

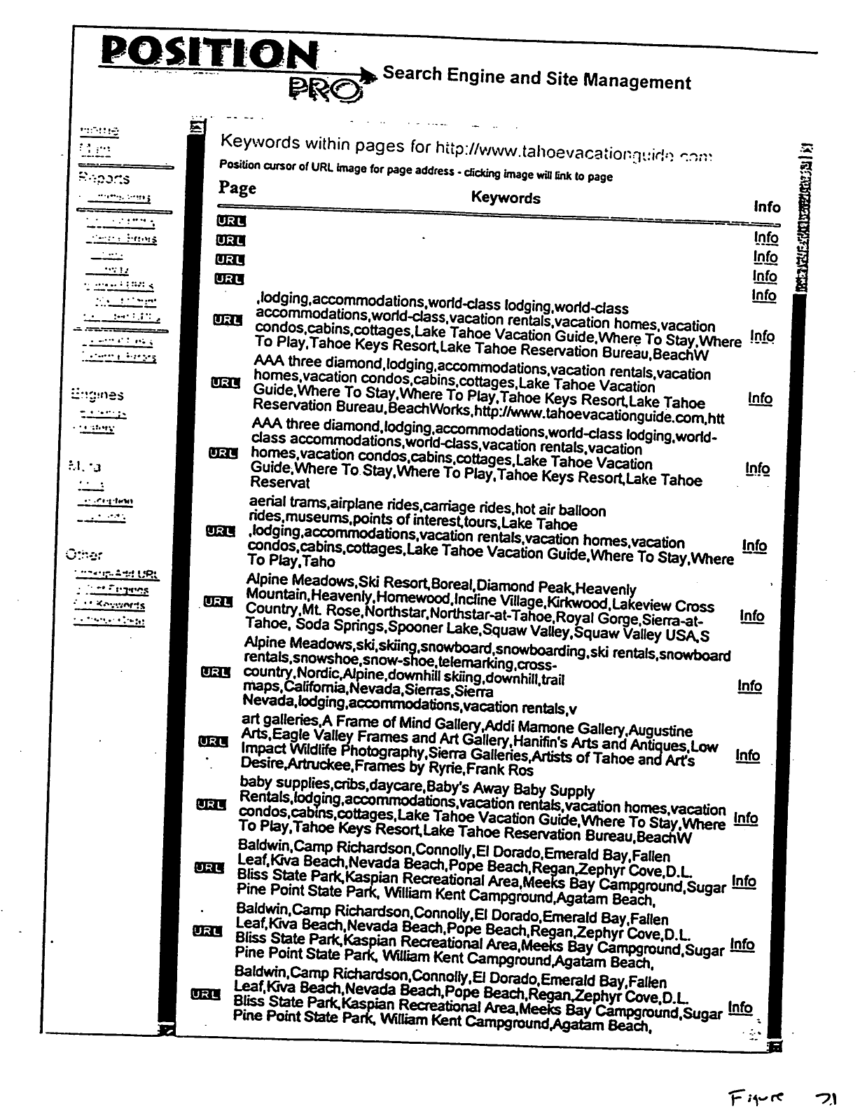

FIG. 21 is a screen shot showing the keywords of all the webpages within the domain that is being submitted to Internet cataloging engines. The screen shot assists in showing whether or not the web programmer is effectively using webpage keywords.

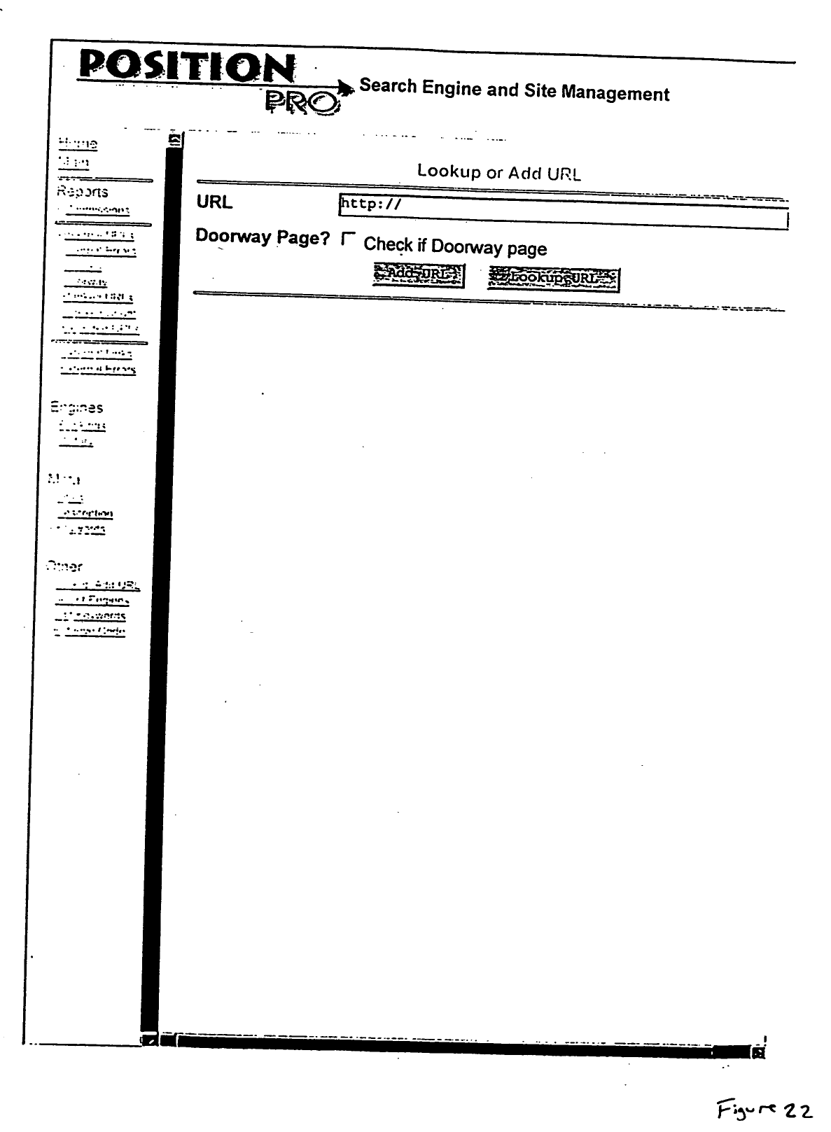

FIG. 22 is a screen shot of a search for webpages.

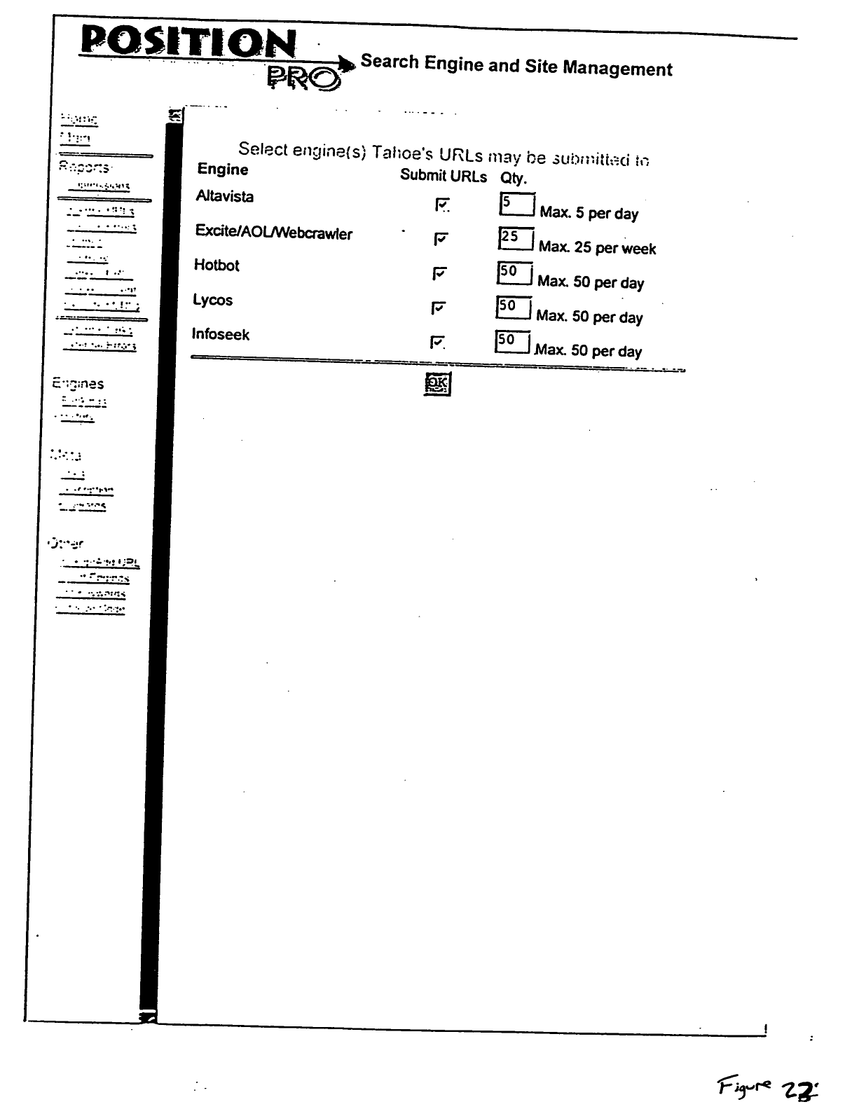

FIG. 23 is a screen shot showing that the user may decide how many webpages to submit to a specific Internet cataloging website per day and per week.

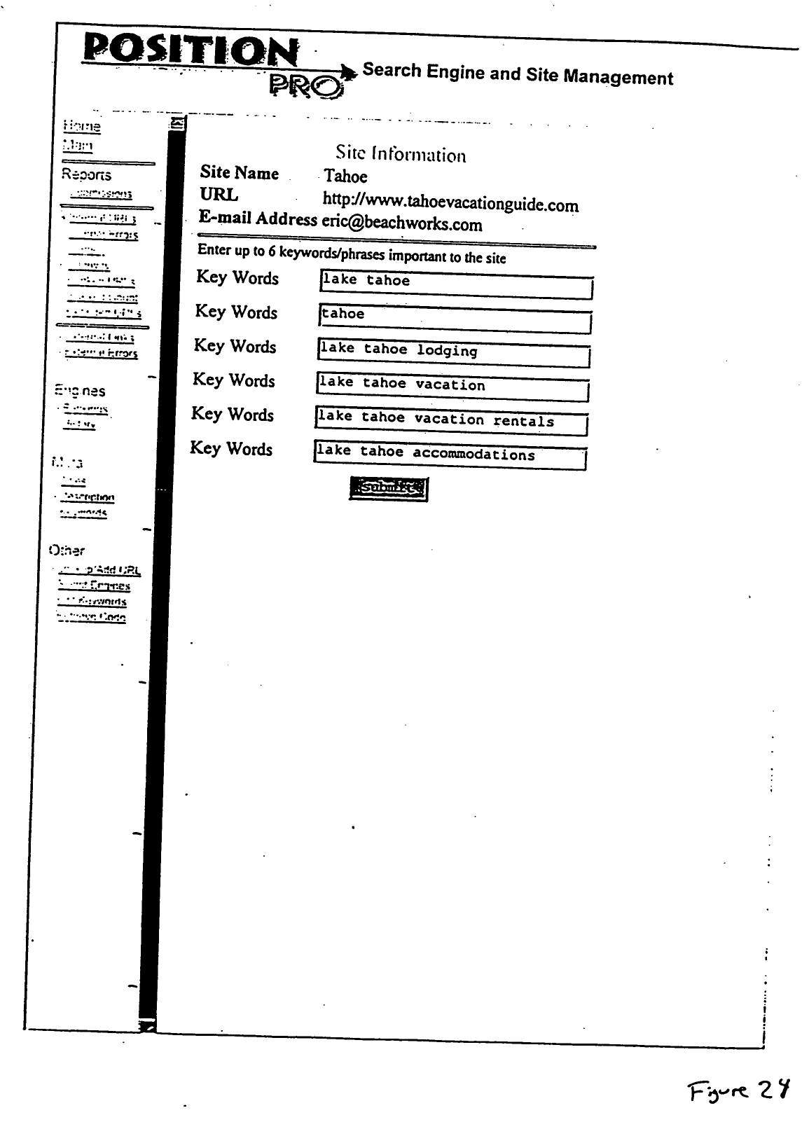

FIG. 24 is a screen shot showing the keywords to be searched when determining whether or not webpages from the domain are found within the Internet cataloging engines.

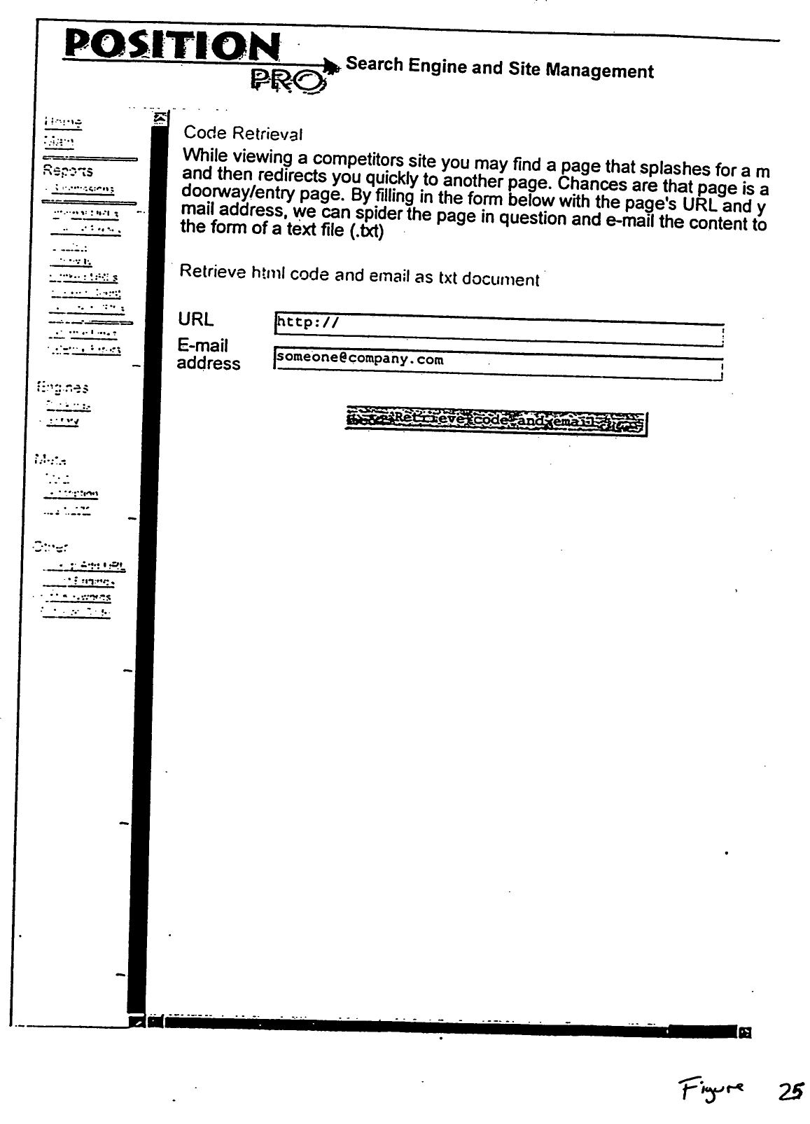

FIG. 25 is a screen shot of a search capability to e-mail the code of a webpage in text format.

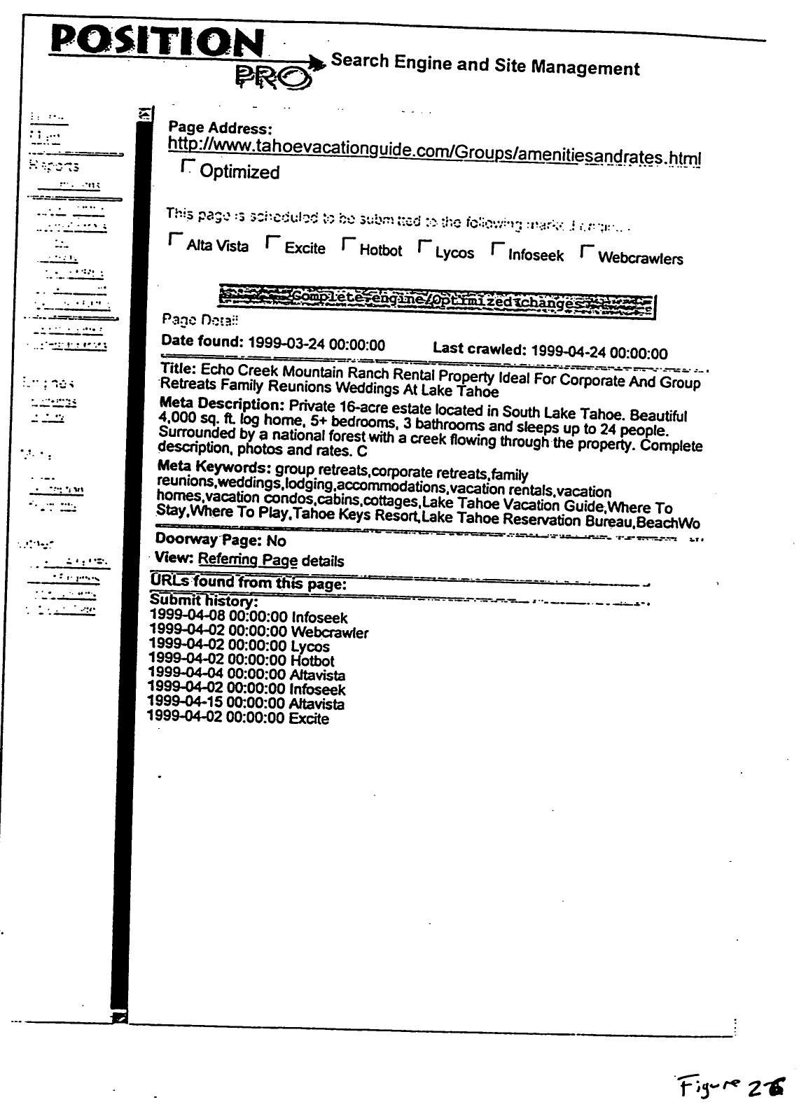

FIG. 26 is a screen shot of detailed information for a specific webpage, the webpage shown is http://www.tahoevacationguide.com/Groups/amenitiesand rates.html. The user may choose which Internet cataloging engines to submit the webpage to. Title, description, and keywords are shown, along with the date the webpage was first found and the date the webpage was last crawled. The webpage referring this webpage is shown. Finally the time and date of each submittal to an Internet cataloging engine is shown.

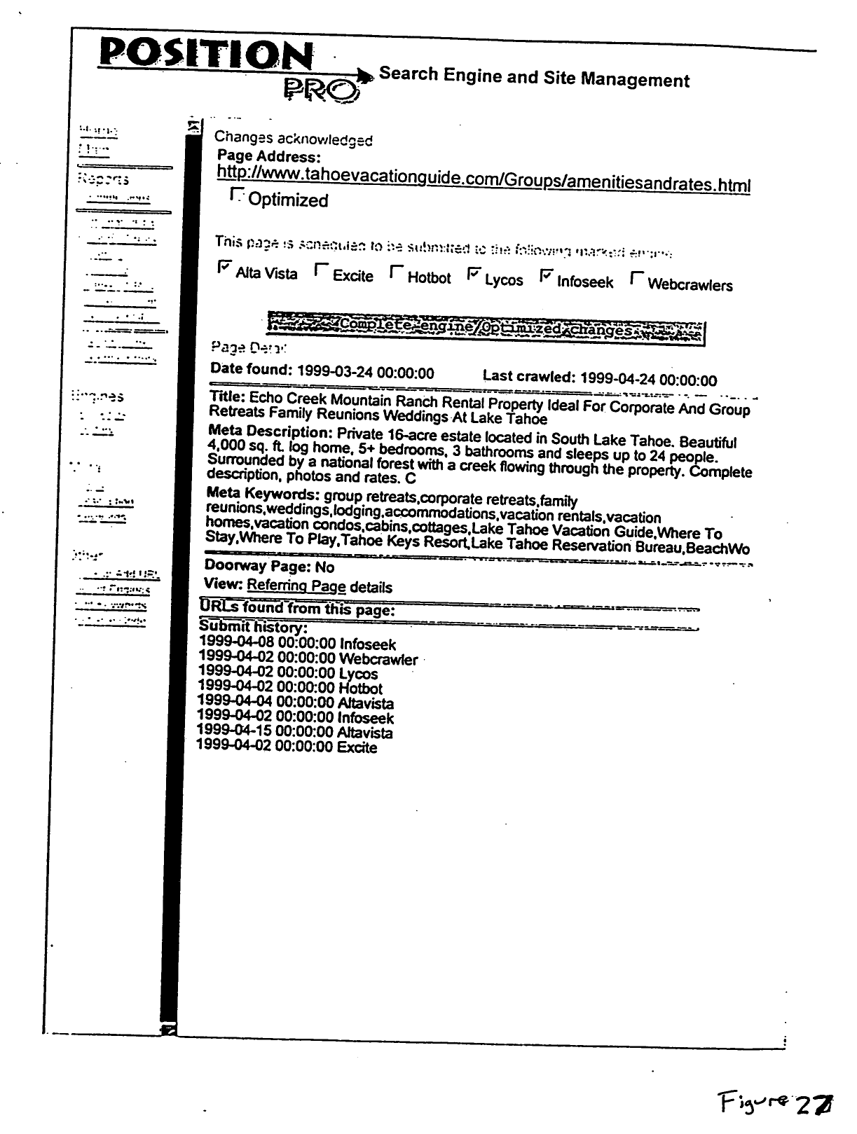

FIG. 27 is a screen shot similar to FIG. 26, however this screen shot shows that the webpage has been scheduled to be submitted to three Internet cataloging engines shown with the checks next to the engines name.

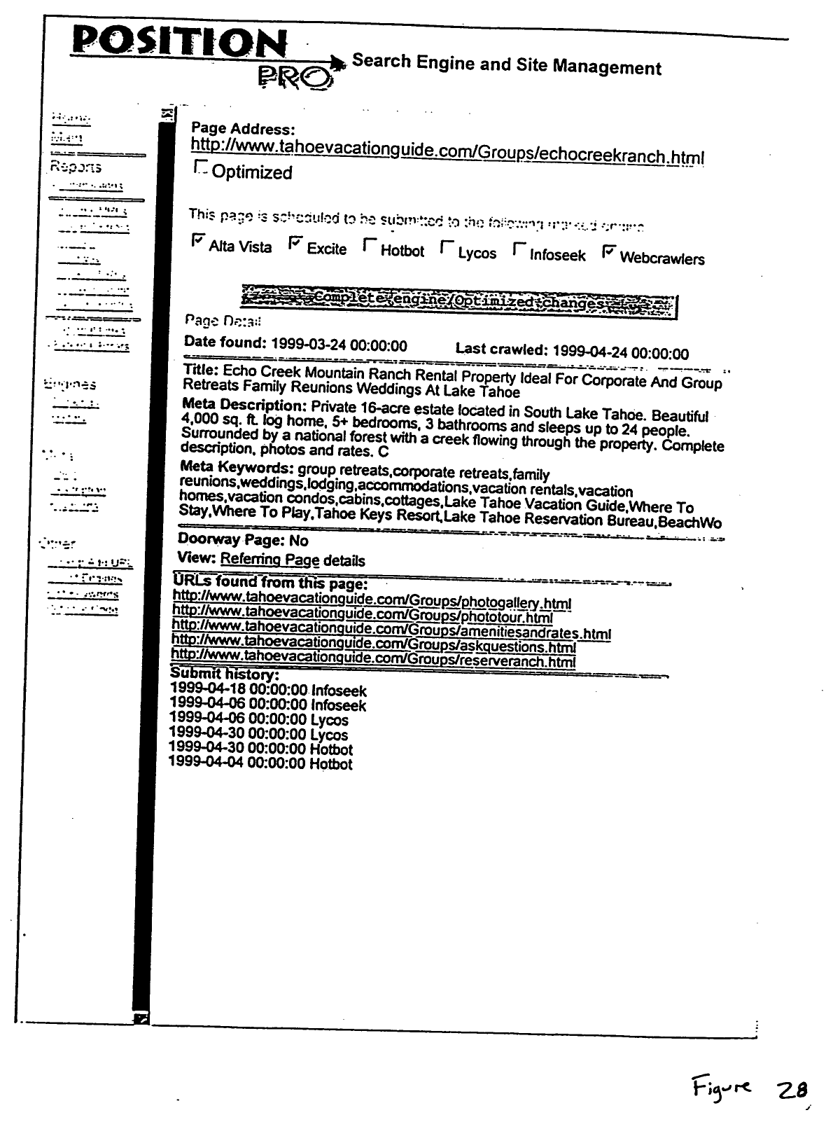

FIG. 28 is a screen shot showing similar information to that in FIG. 26.

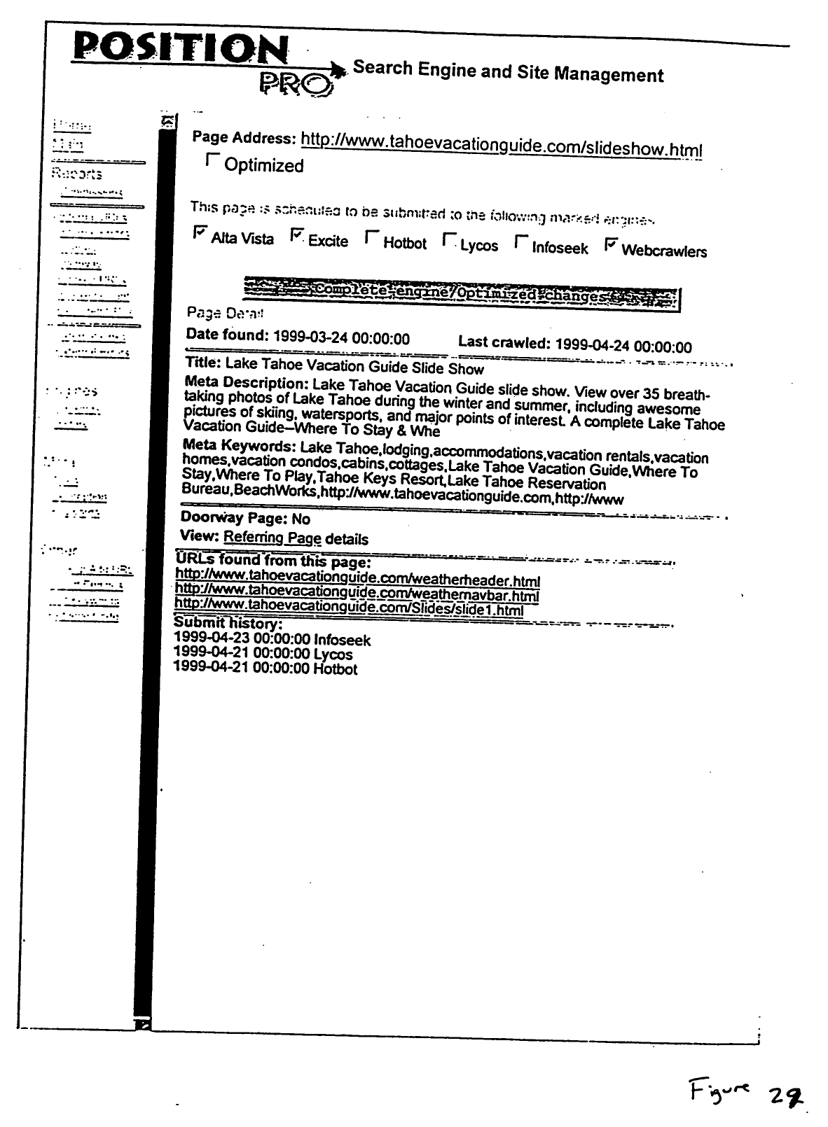

FIG. 29 is a screen shot showing similar information to that in FIG. 26.

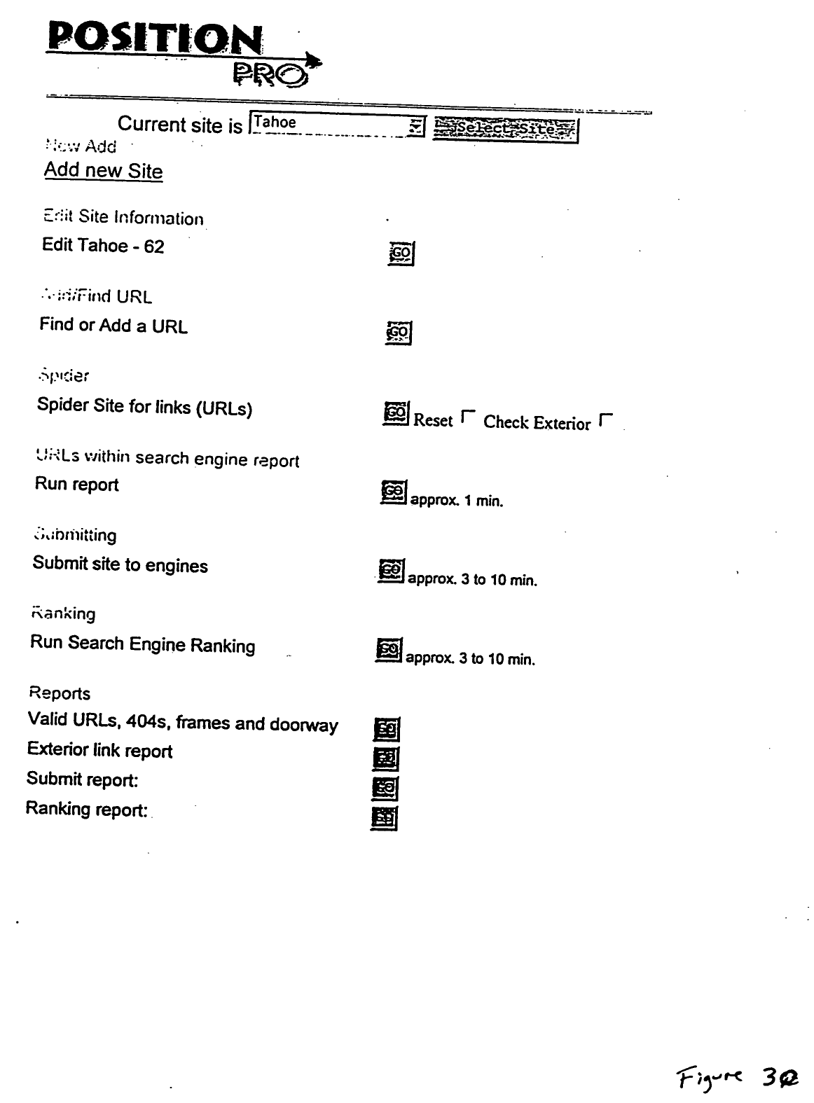

FIG. 30 is a screen shot of administrative functions that may be performed by the programmer maintaining the present invention.

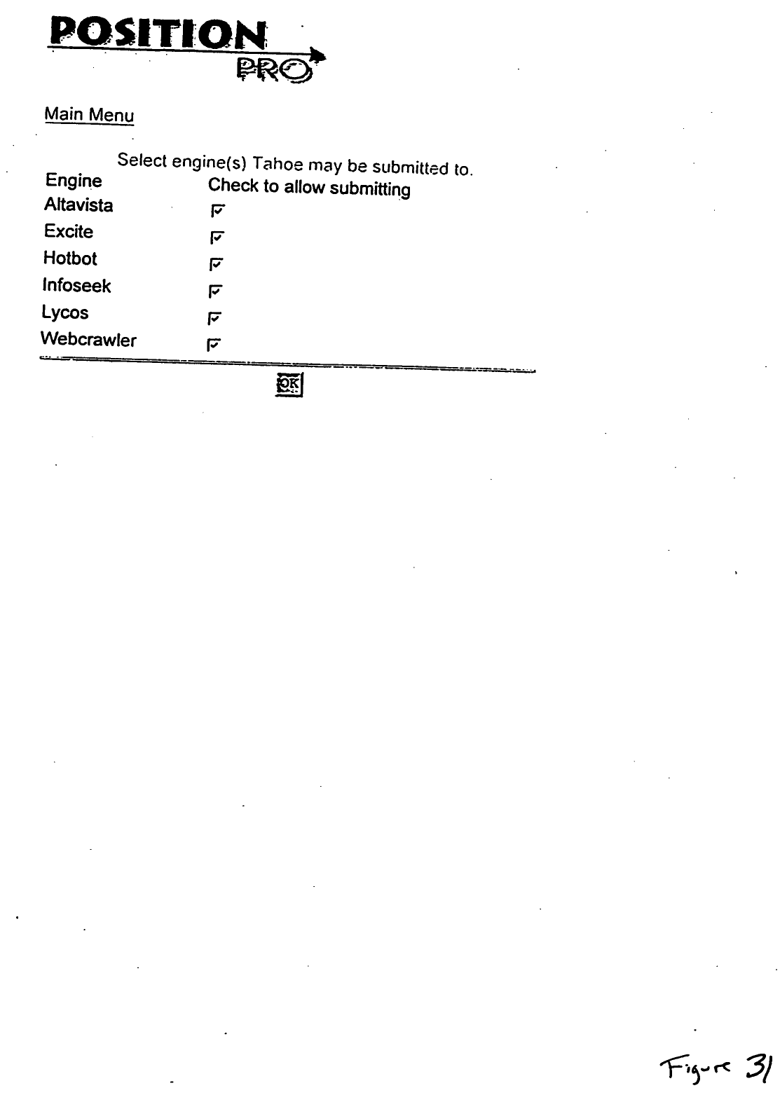

FIG. 31 is another screen shot of administrative functions that may be performed by the programmer maintaining the present invention.

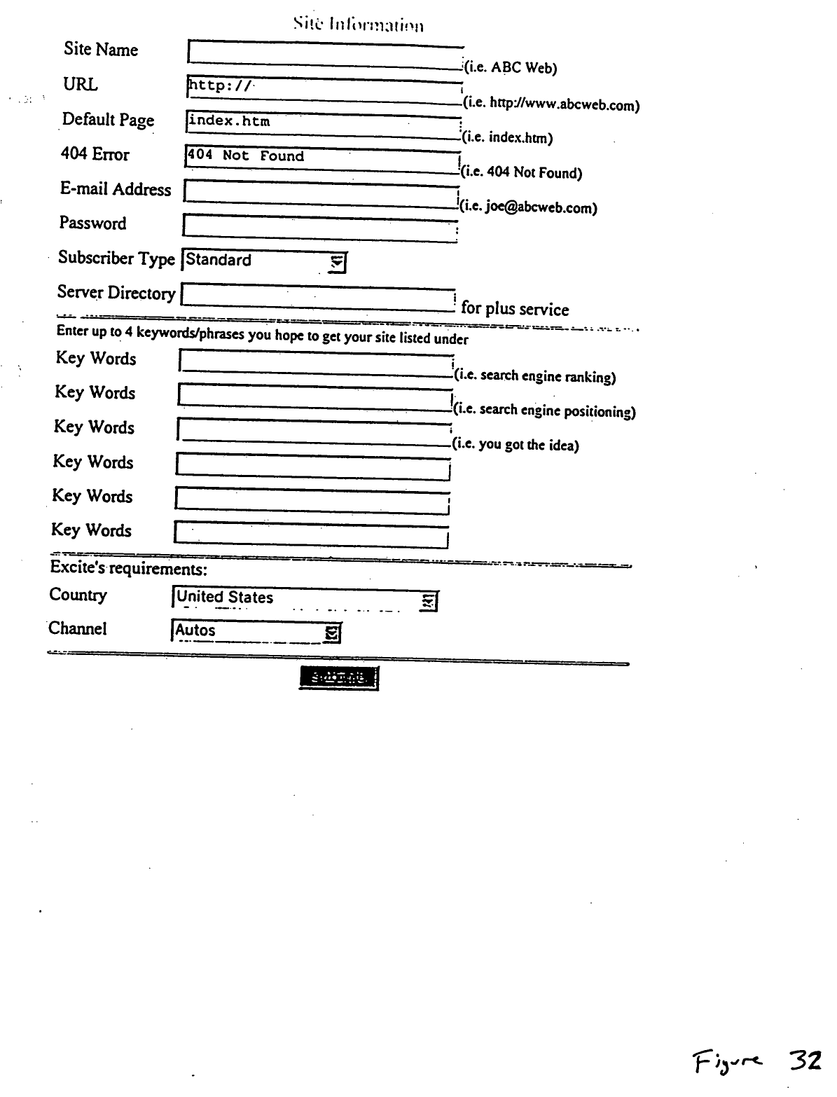

FIG. 32 is another screen shot of administrative functions that may be performed by the programmer maintaining the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. A method for managing files on a network, comprising:
retrieving at least one file name associated with the file;
determining if the at least one file name is to be submitted to a network cataloger from a set of network catalogers;
identifying a set of submission rules associated with the network cataloger;
creating an acceptable uniform resource locator from the at least one file name in accordance with the set of submission rules;
monitoring a ranking assigned by the network cataloger to the acceptable uniform resource locator; and
submitting the acceptable uniform resource locator to the network cataloger in accordance with the set of submission rules and the ranking.

29. The method of claim 28, further comprising re-submitting the uniform resource locator to the network cataloger in accordance with a preferred ranking.

30. The method of claim 28, further comprising:
determining if the at least one file name is to be submitted to another network cataloger from the set of network catalogers;
identifying another set of submission rules associated with the another network cataloger;
creating another acceptable uniform resource locator from the at least one file name in accordance with the another set of submission rules;
monitoring another ranking assigned by the another network cataloger to the another acceptable uniform resource locator; and
submitting the another acceptable uniform resource locator to the another network cataloger in accordance with the another set of submission rules and the another ranking.

31. The method of claim 28, further comprising:
analyzing an updated ranking to ascertain whether the updated ranking comprises an unacceptable updated ranking; and
re-submitting, if the updated ranking comprises an unacceptable ranking, the acceptable uniform resource locator to the network cataloger in accordance with the set of submission rules and at least one of the ranking and the updated ranking.

32. The method of claim 28, wherein retrieving the at least one file name comprises retrieving a name of an external file associated with a site, and wherein creating the uniform resource locator comprises maintaining an association between the uniform resource locator, the name, and the site.

33. A method of claim 28, wherein retrieving comprises retrieving at least one file name associated with a web page found within a frame.

34. A method for managing files on a network, comprising:
retrieving at least one file name associated with a bitmap;
determining if the file name is to be submitted to at least one Internet cataloging engine; and
submitting an acceptable uniform resource locator containing the file name to each of the at least one Internet cataloging engines, each submission being made in accordance with a set of rules associated with the corresponding Internet cataloging engine.

35. A method for managing files on a network, comprising:
retrieving a file name;
determining if the file name is to be submitted to at least one Internet cataloging engine;
identifying a uniform resource locator associated with the file name and containing passable parameters;
creating an acceptable uniform resource locator by removing the passable parameters from the uniform resource locator; and
submitting the acceptable uniform resource locator containing the file name to each of the at least one Internet cataloging engines, each submission being made in accordance with a set of rules associated with the corresponding Internet cataloging engine.

36. A method for managing files on a network, comprising:
retrieving a file name;
determining if the file name is to be submitted to at least one Internet cataloging engine;
pinging each of the at least one Internet cataloging engines to determine whether submission to the at least one Internet cataloging engine would result in error; and
submitting, if submission would not result in error, an acceptable uniform resource locator containing the file name to each of the at least one Internet cataloging engines, each submission being made in accordance with a set of rules associated with the corresponding Internet cataloging engine.

37. A method for managing files on a network, comprising:
retrieving a file name;
determining if the file name has already been submitted to at least one Internet cataloging engine;
comparing current data currently associated with the file name to previous data previously associated with the file name to ascertain if the current data and the previous data are different; and
submitting, if the current data and the previous data are different, an acceptable uniform resource locator containing the file name to each of the at least one Internet cataloging engines, each submission being made in accordance with a set of rules associated with the corresponding Internet cataloging engine.

38. The method of claim 37, wherein comparing comprises comparing current metatag data to previous metatag data.

39. A method for providing information about a site to a network cataloger, comprising:
retrieving at least one file name;
determining if the at least one file name is to be submitted to the network cataloger;
identifying a set of submission rules associated with the network cataloger;
creating a uniform resource locator from the at least one file name;
determining if the submission of the uniform resource locator to the network cataloger would result in an error;
modifying the uniform resource locator to avoid the error; and
submitting the modified uniform resource locator to the network cataloger in accordance with the set of submission rules.
